(19) United States
(12) Patent Application Publication
(10) Pub. No.: US 2026/0291870 A1
(43) Pub. Date: Sep. 24, 2026

(54) SYSTEM

(71) Applicant: SoftBank Group Corp., Tokyo (JP)

(72) Inventor: Toshiharu SASAKI, Tokyo (JP)

(73) Assignee: SoftBank Group Corp., Tokyo (JP)

(21) Appl. No.: 19/567,007

(22) Filed: Mar. 14, 2026

(30) Foreign Application Priority Data
Mar. 19, 2025 (JP) 2025-045093

(51) Int. Cl. H04L 47/125; G06F 40/205; G06F 40/58; G10L 25/63; H04L 9/32

(52) U.S. Cl. CPC H04L 47/125; G06F 40/205; G06F 40/58; G10L 25/63; H04L 9/3242

(57) ABSTRACT

A system includes a processor that is configured to obtain and analyze information from various databases on an information network to identify globally assigned identification information, generate and analyze a prompt sentence that is to be provided to a generative AI model, the prompt sentence being generated based on information received from a user and instructing the generative AI model to perform analysis, and classify information into an appropriate service or department based on a result of the analysis performed by the generative AI model.

### CROSS-REFERENCE TO RELATED APPLICATION

This application is based on and claims priority under 35 USC 119 from Japanese Patent Application No. 2025-045093 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information processing systems that interact with users and backend services typically treat user inputs, network conditions, and service routing as independent processes. In such systems, user-provided information (for example, text, voice, or other input) is often forwarded to fixed services or departments based on static rules or simple keyword matching, without deep analysis or contextual understanding. Furthermore, even when generative AI models are used, prompts are frequently constructed in an ad hoc manner and are not systematically generated or analyzed by the system itself, resulting in suboptimal use of the AI model and inconsistent analysis quality. In addition, user emotions embedded in voice information are generally not utilized for routing decisions or for optimizing the communication environment, so the system cannot adapt to the emotional state of the user. Existing systems also do not systematically identify globally assigned identification information from multiple distributed databases and do not use such identification information in combination with user analysis to create a unified, intelligent routing mechanism. As a result, there is a need for a system that (i) integrates global identification information analysis, (ii) automatically generates and analyzes prompts for a generative AI model based on user information, (iii) adaptively classifies information into appropriate services or departments based on AI analysis results, and (iv) further utilizes user emotion recognition and communication environment optimization to improve user experience and service accuracy.

### SUMMARY

In order to solve the above-described problems, the present invention provides a system comprising a processor, wherein the processor is configured to obtain and analyze information from various databases on an information network to identify globally assigned identification information; generate and analyze a prompt sentence that is to be provided to a generative AI model, the prompt sentence being generated based on information received from a user and instructing the generative AI model to perform analysis; and classify information into an appropriate service or department based on a result of the analysis performed by the generative AI model. In some embodiments, the processor is further configured to acquire voice information of the user and recognize an emotion of the user by using a speech signal processing technique, and to adjust one or more network parameters to optimize a communication environment based on the recognized emotion and generate a unique identification information. By integrating identification of globally assigned identification information, AI-driven prompt generation and analysis, emotion recognition from user voice, and dynamic optimization of communication parameters, the system can intelligently route user-related information to suitable services or departments and improve the reliability, responsiveness, and personalization of user interactions.

The term “processor” refers to one or more hardware processing units, such as a central processing unit (CPU), microprocessor, digital signal processor (DSP), or other computation circuitry, and may also include associated memory and control logic configured to execute instructions.

The term “information network” refers to a communication network, such as the Internet, an intranet, or any combination of wired or wireless networks, that enables data exchange between the system and external devices, servers, or databases.

The term “database” refers to any structured or semi-structured data storage system, including relational databases, NoSQL databases, distributed data stores, or external data services, that store information retrievable by the processor over the information network.

The term “globally assigned identification information” refers to identification information that is allocated or recognized on a global or widely shared basis, such as globally routable IP addresses, globally unique identifiers, or other identifiers that can be resolved or verified using public or shared databases.

The term “user” refers to a human operator, customer, or other person who interacts with the system by providing information, such as text input, voice input, or other forms of data, and who receives responses or services from the system.

The term “prompt sentence” refers to a structured text, sequence of tokens, or other machine-readable instruction that is generated by the processor based on information received from the user and that is provided to a generative AI model to cause the generative AI model to perform a specified analysis or processing task.

The term “generative AI model” refers to an artificial intelligence model, such as a large language model or other machine learning model, that is capable of generating outputs (for example, text, labels, or other data) in response to an input prompt and performing analysis based on learned patterns.

The term “analysis result” refers to data, conclusions, classifications, summaries, or other outputs produced by the generative AI model or by the processor when processing the outputs of the generative AI model.

The term “service” refers to a functional unit, application, backend system, or external or internal process that performs a specific task, such as customer support, billing, technical support, or content delivery, in response to information classified and routed by the processor.

The term “department” refers to an organizational unit within an enterprise or institution, such as a customer service department, sales department, technical support department, or other group, that receives information from the system for handling or further processing.

The term “voice information” refers to audio data representing the speech of the user, including raw audio signals, digitized speech, or processed acoustic features derived from the user's spoken input.

The term “speech signal processing technique” refers to any algorithm or method applied to voice information, including feature extraction, acoustic modeling, pattern recognition, and machine learning techniques, used to analyze and interpret characteristics of the user's speech, such as emotion.

The term “emotion” refers to an affective state of the user, such as happiness, sadness, anger, frustration, neutrality, or other emotional categories, which is inferred by the system from the user's voice information using speech signal processing techniques.

The term “communication environment” refers to the overall technical conditions under which data is exchanged between the user, the terminal, and the server, including network bandwidth, latency, error rates, codec selection, quality of service levels, and other communication-related parameters.

The term “network parameter” refers to a configurable setting or value related to network communication, such as bandwidth allocation, latency threshold, packet size, error correction scheme, protocol selection, or priority level, which can be adjusted by the processor to influence the communication environment.

The term “unique identification information” refers to identification information generated by the processor that is unique within a specified context or namespace, and that can be used to distinguish one user, session, device, or communication context from others.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

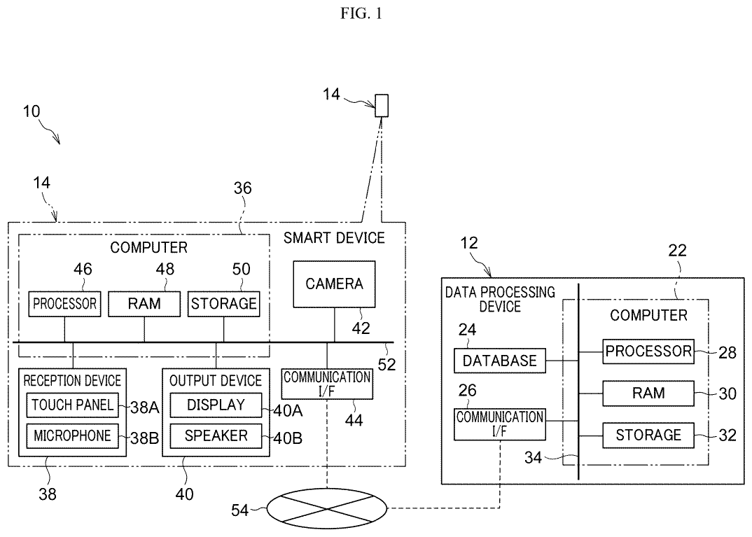

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

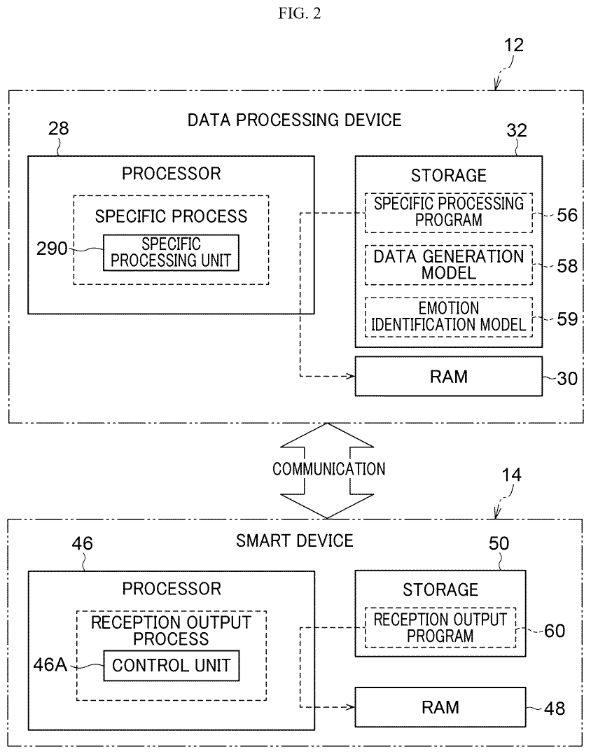

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented identification and routing techniques in networked communication environments suffer from several technical limitations. First, assignment of identification information to user devices is typically tightly coupled to network address translation mechanisms and transient network-layer addresses, which leads to complex state management in network devices, increased processing overhead in middleboxes, and reduced transparency and traceability of end-to-end communication. Second, existing systems often treat user-side contextual information, such as device attributes, communication parameters, and location data, as unstructured metadata that is not systematically normalized and bound to a stable identifier, thereby hindering efficient routing, policy enforcement, and scalable management of user sessions across heterogeneous networks.

Furthermore, in conventional architectures, any adaptive optimization of communication conditions based on user state is rudimentary, if present at all. Emotional or cognitive states of users, which can be inferred from acoustic information or other signals, are generally not integrated into the core identification and routing logic implemented by processors. As a result, network control components are unable to dynamically adjust communication parameters or service selection based on a unified, machine-usable abstraction of both user context and user state.

In addition, while generative information processing models have recently become available, they are usually invoked in a loosely coupled, application-layer fashion, without being structurally integrated into the pipeline that generates and manages unique identifiers and associated routing or classification policies. Known systems do not exploit the capability of such generative models to analyze rich user context and to assist in deriving machine-actionable usage policies that are directly linked to low-level identification and communication control logic. Consequently, processors in these systems cannot consistently translate high-level analytical outcomes into deterministic, cryptographically robust identifiers and corresponding network control actions.

Accordingly, there is a need for a computer technology that improves how a processor acquires global identification information, collects and normalizes user-side context, interacts with a generative information processing model by means of prompt sentences, and deterministically generates cryptographically strong, NAT-independent unique identification information. There is also a need for a processor to use both analytical results from the generative model and recognized user emotional states to classify information, assign identifiers, and optimize communication paths at the system level. The technical challenge is to design and implement a processor-controlled pipeline that integrates prompt-driven analysis, data normalization, cryptographic transformation, and network control parameter adjustment into a cohesive architecture that improves the functioning of the computer system itself, including its routing behavior, identifier management, and adaptive communication control, rather than merely automating an abstract business workflow.

The specific processing by the specific processing unit 290 of the data processing device 12 in Example 1 is realized by the following means.

The present invention provides a server comprising a processor and a memory storing instructions which, when executed by the processor, cause the processor to acquire and analyze identification information that is assigned on a global scale by obtaining the identification information from information sources on an information network; to collect user information including communication information, device information, and location information from a user device, to normalize the user information into a fixed internal representation, and to store the normalized user information in the memory; to generate, based on at least part of the normalized user information and optionally on acoustic information representing a user emotional state, a prompt sentence that instructs a generative information processing model to perform analysis, to transmit the prompt sentence and context data to the generative information processing model, to receive an analysis result from the generative information processing model, and to determine, from the analysis result, a usage policy for the user information and the identification information; to combine at least a portion of the user information into a fixed-format character string in accordance with the usage policy, to apply a cryptographic transformation function to the character string to generate unique identification information that does not require network address translation, and to store in the memory an association among the generated unique identification information, the user information, and the acquired identification information; to assign and deliver the unique identification information to the user device via a communication interface; to acquire acoustic information of the user, to recognize an emotional state of the user by using signal processing on the acoustic information, to reflect the recognized emotional state in at least one of generation of the prompt sentence and parameter selection for the cryptographic transformation function, and to adjust at least one communication control parameter to optimize a communication environment between the server and the user device based on the recognized emotional state and the unique identification information, thereby setting a communication path or a communication resource associated with the user device. This enables the server to implement a technically improved identification and routing mechanism in which normalized user context, generative-model-based analysis, and cryptographic identifier generation are tightly integrated into the processor's operation, resulting in stable NAT-independent identifiers, reduced state complexity in network components, more efficient classification and dispatching of information to processing functions or organizational units, and adaptive optimization of communication conditions based on unified machine-usable representations of user context and emotional state.

The term “system” refers to a combination of at least one processor, at least one memory, and at least one communication interface, together configured to perform the claimed functions for acquiring, analyzing, generating, assigning, and using identification information in a networked environment.

The term “processor” refers to a hardware computing element, such as a central processing unit or a processing core, configured to execute instructions to perform logical operations, data processing, and control of other components of the system.

The term “memory” refers to a hardware storage resource, such as volatile memory or non-volatile memory, configured to store instructions and data used by the processor during execution of the claimed functions.

The term “information network” refers to any communication infrastructure that interconnects multiple information processing devices, including, for example, packet-switched networks, circuit-switched networks, local area networks, wide area networks, or public data networks.

The term “information source” refers to any logical or physical repository of data accessible over the information network, including, for example, databases, registries, directory services, or remote servers that store identification information.

The term “identification information” refers to information that is assigned to an entity on a global scale and that is usable to uniquely distinguish that entity from other entities within a networked environment.

The term “user information” refers to information associated with a user or a user device, including at least communication information, device information, and location information that is acquired and processed by the processor.

The term “communication information” refers to information relating to communication characteristics of a user device, such as network addresses, network identifiers, or connection parameters used during network communication.

The term “device information” refers to information that characterizes a user device, such as a hardware identifier, a network interface identifier, a device class, or an operating environment attribute.

The term “location information” refers to information that indicates a physical position or geographic location associated with a user or a user device, such as coordinates, region identifiers, or position metadata.

The term “user device” refers to an information processing device operated by or on behalf of a user, such as a terminal, a client device, or an endpoint device that communicates with the system over the information network.

The term “normalize” refers to a process of transforming data into a predetermined, consistent, and canonical format, including operations such as formatting, ordering, scaling, encoding, or otherwise standardizing data fields to facilitate deterministic processing.

The term “internal representation” refers to a structured data format, maintained within the memory of the system, that expresses user information or other information in a consistent, machine-usable form for further processing by the processor.

The term “prompt sentence” refers to a machine-readable or human-readable textual sequence or structured expression that instructs a generative information processing model to perform a specified analysis or task on given data.

The term “generative information processing model” refers to a computational model, such as a neural network or other machine learning model, configured to generate outputs including text, labels, or structured data in response to an input prompt and context data.

The term “analysis result” refers to information output by the generative information processing model in response to a prompt sentence, including, for example, classifications, recommendations, or inferred attributes.

The term “usage policy” refers to machine-readable rules or parameters that specify how user information, identification information, or unique identification information is to be handled, processed, classified, routed, or stored by the system.

The term “fixed-format character string” refers to a sequence of characters constructed in accordance with predetermined formatting rules, such that input attributes are combined in a defined order and representation to provide a deterministic input to subsequent processing.

The term “cryptographic transformation function” refers to a function that takes an input value and produces an output value by applying a cryptographic operation, such as a hash function, in a manner that provides properties including collision resistance or one-way transformation.

The term “unique identification information” refers to identification information generated by the processor using the cryptographic transformation function, which is intended to uniquely distinguish a user or a user device within the system and is designed to be independent of network address translation.

The term “network address translation” refers to a process performed by a network device that modifies network address information in packet headers when packets traverse the device, thereby mapping one address space to another.

The term “information storage device” refers to any hardware-based storage component, such as a database system or persistent storage medium, configured to store associations among identification information, user information, and other related data.

The term “acoustic information” refers to information obtained from an audio signal associated with a user, including, for example, voice signals or other sounds captured by a sensing device.

The term “emotional state” refers to a condition inferred from acoustic information or other signals that represents an affective state of the user, such as stress, calmness, or other emotional attributes.

The term “signal processing technology” refers to a set of algorithms or methods applied to acoustic information or other signals to extract features, recognize patterns, or infer attributes such as an emotional state.

The term “communication control parameter” refers to a parameter used to configure or adjust aspects of communication between the system and the user device, such as bandwidth allocation, latency requirements, priority levels, or selection of communication paths.

The term “communication path” refers to a logical or physical route through the information network along which data packets are transmitted between the system and the user device.

The term “communication resource” refers to a network-related resource used for data transmission, including, for example, bandwidth segments, channels, ports, or processing capacity allocated for communication.

The term “processing function” refers to a logical unit of computation or service implemented by the system or associated components, configured to perform specific processing of user information or related information.

The term “organizational unit” refers to a logical or administrative subdivision within an entity, such as a department, group, or functional team, to which information may be classified or routed based on the analysis result or usage policy.

In one embodiment, a server includes at least one processor, a main memory, a non-volatile storage device, and a network interface, all coupled by a system bus. The server is implemented, for example, as a general-purpose computer system equipped with a central processing unit, such as an x86-compatible processor, a memory subsystem including dynamic random access memory, and a storage subsystem including a magnetic disk or a solid-state drive. The server executes an operating system such as a general-purpose server operating system, and application software including a web server process, an application framework process, a database management system process, and a generative AI model serving process.

In one example, the server executes a web server (for example, software of the type of a reverse proxy server) in front of an application framework (for example, software of the type of a Python web framework or a Java web framework). The server executes a relational database management system (for example, software of the type of a SQL database engine) to store user information, identification information, and generated unique identifiers. The server further executes a cryptographic library (for example, software of the type of a hash library conforming to SHA-256) and a generative AI model framework (for example, software of the type of a transformer-based neural network library) on top of the operating system.

A terminal is implemented as a client device equipped with a processor, a memory, a wireless communication interface, and one or more sensors. In one example, the terminal is a smartphone or tablet executing a mobile operating system and a client application. The terminal includes a wireless local area network interface compliant with IEEE 802.11, a location sensor implementing a global navigation satellite system, and an audio input device such as a microphone. The terminal executes application software configured to collect communication information, device information, and location information, and to transmit such information to the server through a secure transport protocol such as HTTPS.

A user operates the terminal by interacting with a user interface. The user initiates a registration or connection procedure by activating a graphical control, and the terminal, in response, requests permission from the user to access location information and audio input. After the user grants permission, the terminal obtains local network parameters, such as an IP address assigned to the terminal, a wireless network identifier (SSID), and a device identifier derived from a network interface. The terminal also obtains geographic coordinates from the location sensor and acoustic information from the microphone when the user speaks a predetermined phrase or naturally during operation.

The terminal normalizes the collected data into a structured internal format. For example, the terminal converts the SSID into lowercase characters, removes delimiter characters from the device identifier, rounds latitude and longitude to predetermined decimal places, and associates a timestamp with each measurement. The terminal then transmits the normalized data to the server using a defined application programming interface endpoint. The data is sent as part of a structured message over a transport layer using the wireless interface and a router, and is received by the server's network interface.

The server receives the message at the web server process, terminates a secure communication session using a cryptographic protocol library, and forwards the request to the application framework. The server uses a structured data parsing library to parse the incoming message and stores the parsed values into a memory-resident data structure such as a record or object including fields for IP address, SSID, device identifier, coordinates, and acoustic features.

In one embodiment, the server preprocesses the acoustic information by applying digital signal processing algorithms. The server computes a time-frequency representation of the audio signal, such as a short-time Fourier transform, and extracts feature vectors including Mel-frequency cepstral coefficients, energy, pitch, and spectral flux. The server aggregates these features over a time window to generate a feature matrix for emotional state recognition.

The server then applies an emotion recognition model implemented as a neural network, for example a multi-layer perceptron or a convolutional neural network, which has been trained offline using labeled audio datasets. The network has an input layer dimension corresponding to the feature vector length, several hidden layers with non-linear activation functions, and an output layer producing probabilities for a predefined set of emotional categories. During training, the model uses a loss function such as cross-entropy and an optimization algorithm such as stochastic gradient descent with adaptive learning rate. During inference in the server, the model receives the feature matrix and outputs a probability distribution. The server selects the emotional category having the highest probability and treats it as the recognized emotional state.

In another embodiment, the server additionally uses a recurrent or transformer-based neural network architecture for emotion recognition, where the sequence of feature vectors over time is fed into a model with self-attention layers. The model captures temporal dependencies in the acoustic signal and produces more robust emotional state predictions, thereby improving accuracy relative to traditional classifiers.

The server also invokes a generative AI model implemented as a transformer-based language model. The generative AI model is deployed either on the same server or on a cooperating computing resource, and is accessible via an application programming interface. The server constructs a prompt sentence by concatenating normalized user information and context descriptions into a natural language instruction or a structured textual command. For example, the server generates a prompt sentence such as:
“Analyze the following user network context and location data: IP address 192.168.0.5, Wi-Fi SSID homewifi, device identifier AABBCCDDEEFF, GPS coordinates 35.6804, 139.7690, and emotional state ‘stressed’. Recommend a usage policy that specifies how to handle the user's data and what priority level to assign for communication.”

The server further constructs an alternative prompt sentence in some embodiments, such as: “Given user network information (IP address, SSID, MAC-like device identifier), location information (latitude, longitude), and a recognized emotional state, determine classification labels for routing the user's requests to appropriate processing functions or organizational units, and recommend whether to generate a high-entropy unique identifier with additional salting.”

The server passes the prompt sentence and associated structured context to the generative AI model. The generative AI model, implemented as a transformer with multiple attention heads and layers, computes attention over the input tokens, propagates activations through feedforward layers, and produces output tokens. The model has been trained on large corpora including technical descriptions and policy rules, and fine-tuned on a domain-specific dataset containing examples of usage policies and routing decisions. The server decodes the output tokens into a textual analysis result containing, for example, a suggested classification label, a recommended priority, and flags indicating whether stricter security is required.

The server does not simply accept the generative AI model output as a final decision. Instead, the server parses the textual output with a rule-based interpreter that extracts specific key-value pairs according to predefined patterns. For example, the server may extract “priority=high”, “classification=security_sensitive”, and “salt_required=true” from the output. The server validates these extracted values against a rule set stored in the database, and if the values are within acceptable ranges and formats, the server commits them to an internal policy representation. This non-conventional integration of generative model output with deterministic rule-based interpretation ensures that the server converts high-level language outputs into precise, machine-actionable parameters, which is a technical improvement over simple text generation.

The server then constructs a fixed-format character string based on the normalized user information and the determined usage policy. The server enforces a predetermined field order and encoding scheme. For example, the server builds a string such as:
“IP=192.168.000.005|SSID=homewifi|DEV=AABBCCDDEEFF|LAT=35.680400|LON=139.769000|PRIO=H|CLASS=SEC_SENS|SALT=xyz123”

The server ensures that numeric values are formatted to fixed widths, string fields are normalized to lowercase, and delimiter characters are reserved. This deterministic construction of the character string ensures that identical inputs always generate identical strings, which in turn guarantees stable hash outputs and allows efficient deduplication and caching in the database. The server applies a cryptographic transformation function such as SHA-256 to this character string using the cryptographic library. The library processes the input in fixed-size blocks, updates an internal hash state, and outputs a 256-bit digest. The server encodes the digest into a representation such as a hexadecimal string and treats this as the unique identification information.

The server stores in the relational database an association among the unique identification information, the underlying user information, the recognized emotional state, and the generated usage policy. The association is stored in a normalized schema with index structures enabling rapid lookup by unique identification information or device identifier. By using the deterministic hash of the normalized string, the server reduces storage redundancy and improves query performance, which leads to lower computational load on the database engine and faster response times.

The server assigns the unique identification information to the terminal by embedding it in a response message. The server sends the response over the network interface through the secure transport session. The terminal receives the response and stores the unique identification information in a secure storage region, such as a secure preference store or a key store. The terminal thereafter includes this unique identification information as a custom header or token in outgoing communications to the server or related network infrastructure. Network control components, such as routers or software-defined networking controllers, can be configured to interpret the unique identification information and to map it to specific routing rules, quality-of-service parameters, or firewall policies. As a result, communication can be established and maintained without reliance on traditional network address translation, thereby simplifying stateful processing at intermediate nodes.

In one embodiment, the server adjusts communication control parameters based on the recognized emotional state and the priority indicated by the usage policy. For example, when the emotional state is recognized as “stressed” and the classification is “support_critical,” the server increases bandwidth allocation and reduces latency by selecting a network path with fewer hops or lower congestion. The server updates routing table entries or instructs a network controller to set higher priority queues for packets tagged with the unique identification information. This specific use of emotional state and generative AI-derived policy to configure low-level communication parameters improves the technical performance of the network, reducing jitter and delay for users in critical states and enabling more efficient utilization of network resources.

In another embodiment, the server applies a modified cryptographic process that adds a policy-dependent salt to the input string before hashing, where the salt is computed from parameters suggested by the generative AI model and validated by the rule engine. By using such a salt, the server increases entropy and further reduces collision probabilities, while still allowing deterministic generation under controlled conditions. The server stores information about salt generation in the database, which allows secure re-derivation or verification of identifiers when necessary.

The technical effect of this architecture is that the server improves the functioning of the computer system itself. The combination of normalized data structures, deterministic string construction, cryptographic hash generation, and AI-assisted usage policies yields stable, globally unique identifiers that are independent of underlying IP address allocation and NAT operations. This reduces the complexity of state tracking in routers and firewalls, lowers the processing overhead for connection mapping, and facilitates faster lookup of device and user context.

Moreover, the generative AI model is not used merely to replace human decision-making in a business workflow. Instead, the model is structurally integrated into the protocol by which the server derives machine-level usage policies, salts, and classification labels from rich contextual features, including emotional state features extracted from acoustic signals. The server uses specific neural network architectures, training procedures, and rule-based post-processing to convert language outputs into well-defined parameters that directly control cryptographic and networking algorithms. This non-conventional pipeline yields improved accuracy in policy selection, reduces misclassification of user context, and lowers the probability of assigning conflicting identifiers, thereby improving reliability and robustness of the identification system.

Alternative embodiments can employ different neural network architectures for the generative AI model, such as encoder-decoder transformers or mixture-of-experts models, and can use different optimization methods, such as Adam or RMSProp, during training. Alternative feature sets can be used for emotion recognition, such as prosodic features or embeddings learned by self-supervised models. The terminal may be a wearable device, an in-vehicle computer, or an industrial control terminal, and the server can be deployed as a cluster of machines running a distributed database and a distributed model-serving infrastructure.

In all embodiments, the server, the terminal, and the user cooperate through the described hardware and software components such that the generation and assignment of unique identification information, the adjustment of communication parameters, and the classification of user information are achieved by coordinated manipulation of structured data, cryptographic functions, and machine-learned models. This coordination produces concrete technical improvements in terms of processing speed, identification accuracy, routing efficiency, and resource utilization, and thus provides a practical application of AI and computer technology beyond the mere automation of human mental tasks.

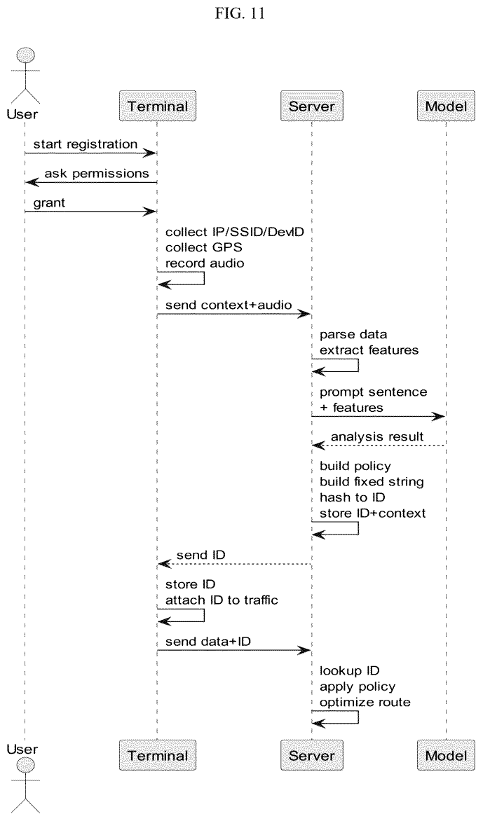

The following describes the processing flow using FIG. 11.

### Step 1

User initiates registration.
User operates the terminal to start the identification process by pressing a registration or connection button on a graphical user interface. As input, the terminal receives the user's interaction event and current OS permission status. Based on this input, the terminal displays dialogs requesting permission to access network information, location services, and microphone audio. The output of this step is a set of granted or denied permissions that will determine which types of data the terminal is allowed to collect.

### Step 2

Terminal collects raw device and network information.
Terminal uses granted permissions as input and calls operating system APIs to read the current IP address, wireless network identifier (SSID), and device network interface identifier. Terminal queries the wireless interface for connection parameters and reads device model and OS version. Terminal aggregates these values into an internal structure. The output is a raw data set containing communication information and device information associated with the terminal.

### Step 3

Terminal collects location information.
Terminal uses the permission result and sensor status as input and invokes location APIs to obtain latitude, longitude, and, optionally, accuracy metrics from a location sensor. Terminal may perform multiple readings and compute an average or filtered value to reduce noise. Terminal then attaches a timestamp to the location data. The output is a location information object containing normalized geographic coordinates and associated metadata.

### Step 4

Terminal collects acoustic information.
Terminal uses the permission result and microphone status as input and activates an audio capture module to record a segment of the user's voice or ambient sound. Terminal samples the audio signal at a predefined sampling rate and stores the samples in a buffer. Terminal may apply basic preprocessing such as noise suppression or volume normalization. The output is an audio data segment that represents acoustic information associated with the user.

### Step 5

Terminal normalizes collected data.
Terminal uses the raw communication information, device information, location information, and acoustic metadata as input. Terminal converts SSID to lowercase, removes delimiters from the device identifier, formats the IP address into a standardized string, and rounds latitude and longitude to fixed decimal places. Terminal packs these values into a structured record and associates a unique local session identifier. The output is a normalized user context record ready to be transmitted to the server.

### Step 6

Terminal transmits normalized data to the server.
Terminal uses the normalized user context record and the audio data segment as input and constructs a request message addressed to a predefined server endpoint. Terminal opens an HTTPS connection, sets protocol headers, and serializes the context record into the request body while attaching the audio data in an agreed format. Terminal sends the request through the wireless interface to the network. The output is a network message received at the server's network interface.

### Step 7

Server receives and parses the request.
Server uses the incoming network message as input and terminates the secure session using a cryptographic library. Server forwards the decrypted payload to an application framework, which parses the structured body and extracts communication fields, device fields, location fields, and a reference to the audio data segment. Server validates formats and value ranges, rejecting malformed entries. The output is a validated internal data object containing user context and a stored audio buffer within server memory.

### Step 8

Server performs acoustic feature extraction.
Server uses the stored audio buffer as input and applies digital signal processing algorithms to compute a time-frequency representation. Server segments the audio into frames, applies a window function, computes spectral coefficients, and derives Mel-frequency cepstral coefficients and other temporal features. Server aggregates these frame-level features into a feature matrix. The output is a numerical feature representation that characterizes the acoustic information.

### Step 9

Server recognizes the user emotional state.
Server uses the acoustic feature matrix as input and feeds it into a trained neural network for emotion recognition. Server performs forward propagation, computing activations across hidden layers and producing an output vector of emotion probabilities. Server selects the emotion class with the highest probability and may also store the probability distribution. The output is a recognized emotional state label and associated confidence values.

### Step 10

Server constructs a normalized context representation.
Server uses the validated user context object and the recognized emotional state as input. Server enforces a canonical field order and encoding rules: it lowercases textual fields, pads numeric values to fixed width, and maps the emotional state to a symbolic code. Server combines these elements into a structured internal representation, such as a record that maps each field to a normalized value. The output is a canonical context representation ready for analysis and identifier generation.

### Step 11

Server generates a prompt sentence for the generative AI model.
Server uses the canonical context representation, emotional state code, and configuration rules as input. Server assembles a natural language instruction that embeds key parameters, such as IP address, SSID, device identifier, coordinates, and emotional state, in a predefined textual template. Server thereby produces a prompt sentence, for example:
“Analyze the following user network context and location data: IP address 192.168.0.5, Wi-Fi SSID homewifi, device identifier AABBCCDDEEFF, GPS coordinates 35.6804, 139.7690, and emotional state ‘stressed’. Recommend a usage policy that specifies how to handle the user's data and what priority level to assign for communication.”
The output is a prompt sentence and structured context that can be submitted to the generative AI model.

### Step 12

Server obtains an analysis result from the generative AI model.
Server uses the prompt sentence and structured context as input and transmits them to a transformer-based generative AI model via a model-serving interface. Server receives tokenized output from the model, decodes it into text, and parses this text using a rule-based interpreter to extract key parameters such as classification labels, recommended priority, requirement for salting, and routing hints. The output is a structured analysis result object containing machine-readable policy suggestions derived from the model output.

### Step 13

Server determines a usage policy based on the analysis result.
Server uses the structured analysis result and a stored rule set as input and applies deterministic rule evaluation to validate and, if necessary, adjust the suggested parameters. Server checks whether the recommended priority and classification are within allowed bounds and whether a salt flag is consistent with security policies. Server then composes a usage policy object defining how to handle user information, how to classify traffic, and how to control identifier generation. The output is a finalized usage policy associated with the user context.

### Step 14

Server constructs a fixed-format character string.
Server uses the canonical context representation and the finalized usage policy as input and concatenates specific fields into a single character string according to a predefined format specification. Server inserts separators, applies zero-padding to numeric values, encodes categorical attributes into short codes, and appends a salt value if the policy requires salting. The output is a deterministic fixed-format character string that uniquely reflects the context and policy.

### Step 15

Server generates unique identification information via a cryptographic function.
Server uses the fixed-format character string as input and passes it to a cryptographic hash function such as SHA-256 through a cryptographic library. Server divides the input into blocks, iteratively updates the hash state, and computes a final hash digest. Server encodes the digest into a hexadecimal string or equivalent representation. The output is a unique identification information value that is independent of network address translation and can be used as a stable identifier.

### Step 16

Server stores associations in a database.
Server uses the unique identification information, the canonical context representation, the emotional state, and the usage policy as input and issues database commands to insert or update records in a relational database. Server writes entries into tables that link the unique identifier to device identifiers, network parameters, and policy attributes, and creates index entries for efficient lookup. The output is a persistent association stored in the database, enabling later retrieval and routing decisions.

### Step 17

Server assigns the unique identification information to the terminal.
Server uses the unique identification information and session context as input and constructs a response message containing the identifier and optional policy hints. Server serializes this data into a response format and sends it via the established secure connection to the terminal. The output is a response message received by the terminal that carries the newly generated unique identification information.

### Step 18

Terminal stores the unique identification information.
Terminal uses the response message as input and parses the payload to extract the unique identification information string. Terminal writes this string into a secure storage location associated with the current user or device profile. Terminal may also record the time of assignment and a version indicator. The output is a locally stored identifier that the terminal can reference in subsequent communications.

### Step 19

Terminal attaches the unique identification information to outgoing communications.
Terminal uses stored unique identification information and application data as input. Terminal modifies its network layer or application-layer communication routines to include the identifier as a header field, token, or parameter in each outgoing request to the server or associated services. Terminal thereby tags every communication with the identifier string. The output is a stream of network messages that consistently carry the unique identification information for routing and control.

### Step 20

Server uses the unique identification information to control communication and routing.
Server uses incoming messages containing the unique identification information as input and performs a lookup in the database to retrieve the associated context and usage policy. Server reads routing rules, priority levels, and resource allocation constraints, and configures internal queues or external network controllers accordingly. Server adjusts communication control parameters, such as bandwidth allocation or queue priority, and selects an appropriate communication path to the terminal. The output is an optimized communication setup and routing behavior that reflect both the user's context and the learned policy, implementing NAT-independent identification and improved technical performance.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional networked computer systems typically rely on static identifiers, such as pre-assigned network addresses, fixed user accounts, or device identifiers, to control access to network resources and backend services. These static identifiers are often managed independently from contextual information such as device configuration, geographic location, and dynamic user conditions. As a result, such systems are vulnerable to identity spoofing, session hijacking, and unauthorized reuse of identifiers across different devices or locations, which leads to increased risk of unauthorized access and data leakage in large-scale communication networks.

In addition, existing server-side workflows that ingest user information and route it to appropriate services often involve manually designed rule sets or narrowly scoped classifiers that do not leverage modern generative information processing techniques. These approaches may be inflexible, hard to maintain, and incapable of handling diverse or ambiguous user inputs in a scalable manner. Consequently, information may not be efficiently classified and dispatched to suitable processing functions or organizational units, leading to degraded system performance and increased operational costs.

Furthermore, many systems do not integrate fine-grained emotional analysis of user inputs, such as voice streams, into their network and application control logic. Without taking into account estimated user emotional states, the system cannot adapt its communication policies, quality-of-service parameters, or interaction strategies to mitigate user distress, detect abnormal behavior, or adjust security posture dynamically. This lack of emotional context results in suboptimal user experience and potentially overlooks signals relevant to security or service integrity.

From the perspective of computer technology, there is therefore a need for a technical solution that: (i) generates robust, dynamically updated unique identification information derived from device configuration information and location information using cryptographic techniques; (ii) tightly integrates such identification information with network-level communication control policies; and (iii) coordinates these mechanisms with server-side generative information processing and emotion-aware adaptation. Such an integrated solution should improve the reliability of identity management, enhance the precision of access control, and increase the efficiency and adaptability of server-side processing flows, thereby improving the overall functioning of computer systems and communication infrastructures.

The specific processing by the specific processing unit 290 of the data processing device 12 in Application Example 1 is realized by the following means.

The present invention provides a server comprising a processor configured to acquire and analyze information related to globally assigned identification information from a plurality of information storage units over an information communication network; generate and analyze instruction information that is created based on attribute information received from a user and that instructs a generative information processing apparatus to perform analysis; classify information into a plurality of information processing functions or organizational functions based on an analysis result provided by the generative information processing apparatus; acquire device configuration information and location information transmitted from a terminal device of the user; combine the acquired device configuration information and the location information in a predetermined order and format to generate a reference character string; generate unique identification information from the reference character string by using a cryptographic hash operation function; determine a communication control policy including at least one of permission and rejection of connection in a communication network based on the unique identification information; and generate and transmit response information for controlling communication from the terminal device in accordance with the communication control policy. This enables dynamic generation and enforcement of context-dependent, cryptographically derived identifiers that are tightly coupled with server-side generative analysis and policy evaluation, thereby improving the security, robustness, and efficiency of computer-based communication control and information routing.

The term “system” refers to a collection of hardware components and software components that cooperate to perform one or more information processing functions within a communication environment.

The term “processor” refers to one or more hardware-based processing units, such as a central processing unit or a processing circuit, configured to execute instructions and perform arithmetic and logical operations.

The term “information communication network” refers to an infrastructure of interconnected communication paths, nodes, and devices that enables transmission and reception of digital information between endpoints.

The term “information storage unit” refers to any hardware or software-based data storage resource, including a database, memory device, or external storage service, that stores information accessible over an information communication network.

The term “globally assigned identification information” refers to identification information that is uniquely allocated on a global scale to entities such as network nodes, devices, or services, and that is used to distinguish such entities across multiple networks.

The term “attribute information” refers to information that characterizes a user, a device, or a context, including but not limited to user profile data, usage intent, application type, or other descriptive parameters supplied by the user.

The term “instruction information” refers to information that is generated by the processor based on attribute information and that specifies an operation, an analysis, or a processing task to be performed by another processing apparatus.

The term “generative information processing apparatus” refers to a computing apparatus that implements a generative AI model or other generative algorithm to analyze input information and produce corresponding output information, such as classifications, predictions, or generated content.

The term “analysis result” refers to output data produced by the generative information processing apparatus in response to input information and instruction information, including but not limited to classification labels, extracted features, or generated responses.

The term “information processing function” refers to a logical function or software module that performs an operation on input information, such as filtering, transforming, routing, or storing the information.

The term “organizational function” refers to an operational unit or functional division within an organization, such as a service department, support group, or business unit, that is responsible for handling specific categories of information or tasks.

The term “terminal device” refers to an endpoint device operated by a user, including but not limited to a mobile device, a personal computer, or any user equipment capable of communicating with the server over an information communication network.

The term “device configuration information” refers to information describing hardware and software characteristics of a terminal device, including device type, model, operating system, network interface parameters, and other configuration-related attributes.

The term “location information” refers to information indicative of a geographic position of a terminal device or user, such as coordinates, region identifiers, or other spatial descriptors.

The term “reference character string” refers to a character sequence generated by combining device configuration information and location information in a predetermined order and format, and used as an input to a cryptographic hash operation.

The term “cryptographic hash operation function” refers to a function that takes input data and deterministically produces a fixed-length hash value, with properties including collision resistance and preimage resistance, suitable for security-related applications.

The term “unique identification information” refers to identification information, such as a hash value or derived identifier, that is generated from a reference character string and is intended to uniquely correspond to a specific combination of device configuration information and location information.

The term “communication control policy” refers to a set of rules or conditions used by the processor to determine how communication in a network is to be handled, including at least whether to permit or reject connection requests associated with specific identification information.

The term “response information” refers to information generated by the processor and transmitted toward a terminal device to indicate a communication control policy decision and to control subsequent communication behavior of the terminal device.

The term “voice information” refers to digital data obtained from acoustic signals produced by a user, including speech signals captured by a microphone or other audio acquisition component.

The term “signal processing technology” refers to one or more algorithms or techniques applied to digital signals, such as filtering, feature extraction, or pattern recognition, in order to analyze, classify, or interpret the signals.

The term “emotional state” refers to a characteristic condition inferred for a user, such as satisfaction, frustration, stress, or calmness, estimated based on analysis of voice information or other behavioral signals.

The term “communication path identifier” refers to an identifier derived from unique identification information and used to identify a communication path, flow, or channel in a network for the purpose of routing or resource allocation.

The term “network resources” refers to computational, bandwidth, addressing, or routing resources in a communication network, including processing capacity, communication channels, and storage resources associated with network operation.

The term “communication environment parameters” refers to parameters that define or influence communication quality, such as bandwidth allocation, latency targets, priority levels, or quality-of-service settings applied to network traffic.

In one embodiment, a server implements the claimed system as a network-accessible backend executed on one or more processors, main memory units, and non-volatile storage devices. The server operates under a general-purpose operating system such as a Unix-like operating system and executes an application framework such as a web application framework written in a high-level programming language. The server cooperates with at least one terminal and at least one user over an information communication network that may include wireless access networks, local area networks, and wide area networks.

The server acquires information related to globally assigned identification information from a plurality of information storage units. The server accesses distributed data repositories, such as relational databases and directory services, by using database client libraries and network protocols. The server retrieves records that contain, for example, network-layer identifiers, addressing information, and registration records associated with devices and services deployed across the network. The server parses these records into internal data structures, such as key-value maps and normalized tables, and analyzes them to determine uniqueness conditions, allocation ranges, and conflict patterns of existing identifiers. By maintaining and updating such a global identifier context, the server improves the accuracy and collision resistance of subsequently generated unique identification information.

The terminal provides device configuration information and location information to the server. The terminal includes hardware components such as a processor, memory, a wireless communication interface, and at least one sensor, for example a positioning sensor. The terminal executes an application that uses platform-specific application programming interfaces to read device model, operating system version, network interface properties, and other configuration-related attributes. The terminal uses a location service to calculate geographic coordinates based on signals from positioning satellites, wireless access points, or other positioning infrastructure. The terminal aggregates these values into a structured internal object in memory, normalizes the representation, and transmits the information to the server using a secure communication channel.

The server receives device configuration information and location information from the terminal and combines them into a reference character string. The server defines a predetermined field order and encoding rule, such that all device models, operating system identifiers, hostnames, and coordinate values are normalized into canonical textual tokens. The server converts numeric values, such as latitude and longitude, into strings with fixed precision, for example six decimal digits, and concatenates them with delimiters into a single string. This canonicalization process ensures that the same combination of device configuration information and location information always results in the same reference character string, which reduces ambiguity and improves determinism of subsequent cryptographic operations.

The server generates unique identification information from the reference character string by using a cryptographic hash operation function. The server applies a hashing algorithm, such as a secure hash function with a fixed output length, to the reference character string encoded as a byte sequence. The server feeds the byte sequence into the hashing algorithm implemented in a cryptographic library, which is optimized for the processor architecture.

The server receives a fixed-length hash value and encodes it as a compact textual representation, such as a hexadecimal string. Because the cryptographic hash operation function exhibits collision resistance and sensitivity to input changes, even small variations in device configuration information or location information produce substantially different hash values. As a result, the server obtains unique identification information that robustly represents the current state and context of the terminal.

The server optionally converts the unique identification information into a communication path identifier that can be used directly within a network protocol. In one example, the server interprets a portion of the hash value as an integer and maps this integer into a network-layer address space, such as an address space for a next-generation Internet protocol. The server uses a software library for network address manipulation to ensure that the resulting address conforms to protocol syntax and reserved range constraints. By deriving network-layer identifiers from cryptographic hashes of device configuration information and location information, the server tightly couples network routing or addressing with the physical and logical context of the terminal. This mapping allows network devices to recognize and enforce context-aware policies directly at the network layer.

The server determines a communication control policy based on the unique identification information. The server maintains a policy rule set in an internal database or in a rules engine. These rules reference attributes such as geographic region, device type, operating system version, and the presence or absence of known vulnerabilities or compliance flags. The server uses the unique identification information and, in some embodiments, the derived communication path identifier as keys to look up previously stored trust levels or access rights. The server executes decision logic that evaluates multiple conditions, such as allowed countries, minimum software versions, and known anomaly patterns associated with specific identifiers. This evaluation produces a communication control policy that may include permission or rejection of network access, bandwidth limits, quality-of-service priorities, or logging requirements. Because the server bases its decisions on a hash-derived, context-sensitive identifier rather than on static credentials alone, the system reduces the likelihood that identifiers can be reused illegitimately in different environments, which improves security.

The server generates and transmits response information to the terminal according to the communication control policy. The server constructs a response structure in memory that includes a policy decision, the generated unique identification information, and optionally the communication path identifier and validity period. The server serializes this structure into a textual message and sends it back to the terminal over the secure communication channel. The terminal receives this response, parses the message, and configures its network stack or application-level behavior accordingly. For example, the terminal may select a particular virtual network interface, adjust the endpoints it contacts, or include the unique identification information as a token in future protocol messages. This interaction creates a closed loop in which the server and the terminal cooperate to enforce dynamic, context-sensitive communication control.

In another embodiment, the server also processes voice information from the user to estimate an emotional state and to adapt instruction information for a generative AI model and communication control policy. The terminal captures voice data via a microphone and transmits digitized audio frames to the server. The server stores the frames in a buffer and applies signal processing algorithms to extract features such as spectral coefficients, pitch contours, energy measures, and temporal patterns. The server feeds these features into a trained neural network model for emotion recognition. In one example, the neural network includes a series of convolutional layers that capture local time-frequency patterns, followed by recurrent layers, such as gated recurrent units or long short-term memory units, that model temporal dependencies, and a final fully connected layer that outputs probabilities for discrete emotional categories.

The server trains the emotion recognition model offline using labeled datasets of speech samples and associated emotional labels. During training, the server uses a loss function, such as cross-entropy between predicted probabilities and ground-truth labels, and updates network weights by backpropagation with an optimization algorithm such as stochastic gradient descent with momentum or an adaptive optimization method. The server performs data augmentation on the audio by applying random noise, pitch shifts, or speed variations to increase robustness. These training procedures result in a model that efficiently maps high-dimensional acoustic features to emotional states with improved accuracy compared to simpler heuristic or rule-based methods.

The server uses the estimated emotional state as an additional input variable when generating instruction information for the generative AI model and when determining the communication control policy. For example, if the server detects a high-stress or frustration state, the server may generate instruction information that requests the generative AI model to produce more detailed, stepwise guidance or to route the user's query to a support function with higher priority. The server may also reduce the aggressiveness of security challenges during recognized emergency conditions to avoid blocking critical communications, or conversely tighten security when anomalous emotional patterns indicate possible fraud or coercion. By incorporating emotional state into policy decisions, the system achieves a more adaptive and nuanced control of network resources and service behavior, which can improve both user experience and security.

The server implements the generative AI model as a neural network-based text processing module deployed on the same hardware or on a connected accelerator resource. The generative AI model in one embodiment is a transformer-based sequence model comprising multiple layers of self-attention and feedforward sublayers. The server supplies the model with tokenized representations of user-provided attribute information and system context, including domain tags, device class, and emotional state indicators. The server maintains an embedding matrix that maps discrete tokens to continuous vectors, and the model processes these vectors through attention heads that compute context-dependent representations of each token. The model outputs a sequence of tokens representing instruction information, such as a prompt sentence specifying the analytical task to be performed by another generative AI model or a downstream processing pipeline.

The server trains or fine-tunes the generative AI model using task-specific datasets that contain pairs of input contexts and desired instruction outputs. During training, the server minimizes a loss function that measures divergence between the generated token sequence and a reference token sequence, and updates model parameters according to gradient-based optimization. The model thereby learns to produce concise and precise instruction information that effectively triggers the intended analysis or processing tasks in downstream components. Because the generative AI model captures complex syntactic and semantic patterns of user requests and system constraints, it can produce instruction information with fewer tokens and greater specificity compared to rule-based template systems, which improves processing efficiency and reduces communication load.

The server includes a classification mechanism that assigns incoming information, along with model-generated instruction information and analysis results, to appropriate information processing functions or organizational functions. The server represents each function as an entry in a routing table with associated capability descriptors, such as supported data types, priority levels, and required security clearance. The server encodes analysis results, including embeddings from internal layers of the generative AI model, into a compact vector representation. The server then applies a similarity search or a learned routing classifier to match the vector representation to function descriptors and selects a target function. This approach allows the server to route complex or ambiguous requests to the most suitable processing module without hand-crafted rules, which improves scalability and reduces misrouting rates.

The server thereby improves computer technology in several ways. First, by deriving unique identification information from combined device configuration information and location information through cryptographic hashing, the server strengthens binding between logical identifiers and physical context, which reduces opportunities for identifier reuse and spoofing and directly improves network security mechanisms. Second, by integrating these identifiers into communication path identifiers used in network-layer addressing and routing, the server enables network elements to enforce context-aware policies more efficiently, reducing the need for repeated high-level authentication exchanges and thereby decreasing communication overhead and latency. Third, by using trained neural network models for both generative instruction generation and emotion recognition, the server achieves more accurate and compact representations of user intent and status, which leads to fewer processing steps, lower bandwidth consumption, and more precise resource allocation than traditional rule-based systems.

The server further implements specific data structures and processing flows to realize these improvements. Device configuration information and location information are stored in normalized records with fields indexed by hash-derived keys, enabling rapid lookup of prior contexts. The server maintains a cache of computed hash values and corresponding communication control policies, so that repeated connections from the same terminal in similar conditions can be processed with constant-time lookups instead of recomputing cryptographic operations and policy evaluations. The generative AI model and emotion recognition model share a feature extraction backend, such as a common encoder network, so that intermediate representations can be reused instead of recomputed, which reduces computation and energy consumption.

The terminal benefits from these server-side improvements by receiving compact control instructions and identifiers that can be applied at the operating system network stack level. For example, the terminal may assign the derived communication path identifier to a virtual interface and configure packet filters to tag outgoing traffic accordingly. The terminal may also adjust polling intervals, retransmission timeouts, or buffer sizes based on policy parameters provided by the server, thereby optimizing resource usage on constrained devices such as mobile terminals.

The user interacts with the system via user interfaces on the terminal. The user may, for instance, initiate an operation by entering a free-form request, which the terminal sends as attribute information to the server. An example of a prompt sentence generated or used in such a context is:
“Create a detailed Python backend program that runs on a server and performs the following operations: 1) Receive device information (device model, OS version, hostname) and location information (latitude and longitude) in JSON format via an HTTPS POST request; 2) Parse and validate the JSON data using a web framework such as Flask; 3) Construct a canonical UTF-8 string from the fields in a fixed order, then compute a SHA-256 hash using the hashlib library; 4) Convert the first 128 bits of the hash into an IPv6 address using the ipaddress. IPv6Address class; 5) Store the hash, the IPv6 address, and a timestamp in a PostgreSQL database; 6) Evaluate a simple security policy (for example, allow access only if the location is in Japan) and return a JSON response that includes the decision (allowed or denied), the hash value, and the IPv6 address. Also provide an example of a JSON request body that a terminal would send to this server.”

The server uses such a prompt sentence as instruction information to drive a generative AI model that produces executable-level descriptions or configurations for the backend workflow. Because the server combines this generative capability with cryptographic identifier generation and network policy enforcement tightly coupled to device and location context, the overall system delivers technical improvements in security, processing efficiency, and communication overhead that extend beyond mere automation of human decision-making or administrative routing.

In alternative embodiments, the server may employ different cryptographic hash functions, different neural network architectures, or different mapping schemes from hash values to communication path identifiers, provided that the server continues to link device configuration information and location information to unique identification information and to use this identification information for communication control. The server may also distribute modules across multiple physical machines, such that one machine performs cryptographic hashing and policy evaluation, another machine executes the generative AI model, and another stores global identifier information. In each case, the cooperation among the modules and their specific dataflows maintain the technical advantages described above.

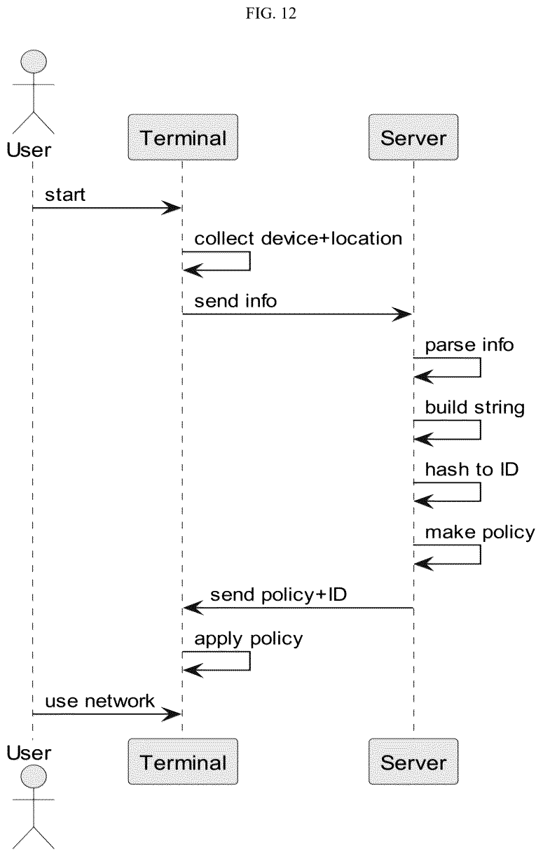

The following describes the processing flow using FIG. 12.

### Step 1

The terminal acquires device configuration information and location information.
The terminal uses operating system APIs to read hardware and software attributes, such as device type, model name, operating system name and version, and network interface characteristics, and stores these attributes in a structured in-memory object. The terminal concurrently invokes a location service that uses sensors and communication interfaces to determine geographic coordinates, such as latitude and longitude, and appends these coordinates to the same object.
Input: raw hardware status signals, software metadata provided by the operating system, and sensor data for positioning.
Processing: the terminal converts low-level signals and metadata into normalized fields (for example, strings for model and OS, floating-point numbers for coordinates) and aggregates them into a single logical data record.
Output: a normalized device-and-location record containing device configuration information and location information.

### Step 2

The terminal transmits the device-and-location record to the server.
The terminal opens a secure communication session toward the server by establishing a connection using a transport security protocol. The terminal serializes the device-and-location record into a structured text representation and encapsulates this representation into a request message directed to a predefined endpoint on the server.
Input: the normalized device-and-location record generated in Step 1.
Processing: the terminal encodes the record into a text format, attaches appropriate headers and addressing information, and applies encryption and integrity protection at the transport layer.
Output: an encrypted network request containing the device configuration information and location information, delivered to the server.

### Step 3

The server receives and parses the incoming request from the terminal.
The server accepts the encrypted network request on a listening port, terminates the secure session at a communication interface, and forwards the decrypted payload to an application process. The server parses the structured text payload, validates required fields, and reconstructs the device-and-location record in internal data structures.
Input: the encrypted network request containing the serialized device configuration information and location information.
Processing: the server performs decryption, integrity verification, protocol decoding, text parsing, and schema validation to transform the request payload into typed fields.
Output: a validated internal representation of the device configuration information and location information in server memory.

### Step 4

The server canonicalizes the device configuration information and location information into a reference character string.
The server applies a deterministic ordering rule to the fields of the internal representation and converts each field value into a text fragment with standardized formatting, such as fixed decimal precision for coordinates and normalized casing for textual identifiers. The server concatenates these text fragments with predefined delimiters to form a single reference character string.
Input: the validated internal representation of device configuration information and location information from Step 3.
Processing: the server performs field selection, normalization (including trimming, case conversion, and numerical formatting), ordering, and concatenation to remove ambiguity and ensure that identical inputs always produce identical character strings.
Output: a canonical reference character string representing the combined device configuration information and location information.

### Step 5

The server generates unique identification information by applying a cryptographic hash function to the reference character string.
The server converts the reference character string into a sequence of bytes using a fixed character encoding. The server feeds this byte sequence into a cryptographic hash computation module, which executes a series of bitwise and arithmetic operations on the input data to produce a fixed-length hash value. The server then encodes this hash value into a compact textual form suitable for storage and comparison.
Input: the canonical reference character string obtained in Step 4.
Processing: the server performs character encoding, hash computation using a cryptographic algorithm, and binary-to-text conversion to transform the string into a fixed-length, collision-resistant identifier.
Output: unique identification information represented as a fixed-length textual hash value.

### Step 6

The server optionally derives a communication path identifier from the unique identification information.
The server interprets at least a portion of the hash value as a large integer and maps this integer into a communication address space, such as an address space for a network-layer protocol. The server formats the resulting integer according to protocol rules to produce a valid communication path identifier.
Input: the unique identification information produced in Step 5.
Processing: the server performs substring selection or binary extraction from the hash, integer conversion, modulus or range mapping if required, and protocol-specific formatting to obtain a usable path identifier.
Output: a communication path identifier that can be used for routing or addressing in a communication network.

### Step 7

The server evaluates a communication control policy based on the unique identification information and contextual data.
The server consults a policy data store that contains rules parameterized by location constraints, device types, software versions, and known trust states associated with identifiers. The server uses the unique identification information and, when available, the communication path identifier as keys to retrieve historical records and to match applicable rules. The server executes a decision procedure that aggregates rule outcomes to determine whether to permit or reject network connection, and may also compute additional parameters, such as bandwidth limits or monitoring requirements.
Input: the unique identification information from Step 5, the communication path identifier from Step 6 (if present), and policy records stored in the server.
Processing: the server performs database lookups, rule evaluation, conditional branching, and calculation of quantitative parameters to transform identifiers and context into a specific communication control policy.
Output: a communication control policy specifying at least one of connection permission, connection rejection, and quality-of-service parameters.

### Step 8

The server generates response information conveying the communication control policy to the terminal.
The server constructs a response object that includes the policy decision, the unique identification information, and, when applicable, the communication path identifier and validity intervals. The server serializes this object into a response message, attaches necessary headers, and sends the message to the terminal over the established secure session or a newly initiated session.
Input: the communication control policy produced in Step 7 and the associated unique identification information and communication path identifier.
Processing: the server formats policy fields into a structured text representation, encapsulates the representation into a network response message, and applies encryption and integrity protection at the transport layer.
Output: a secure response message containing response information that encodes the communication control policy and identifiers.

### Step 9

The terminal receives the response information and configures communication behavior accordingly.
The terminal accepts the response message from the server, performs decryption and integrity verification, and parses the structured text payload. The terminal reads the policy decision and associated identifiers and updates its local network configuration, for example by marking the current session as authorized, associating the communication path identifier with a particular interface, or updating cached credentials for subsequent requests.
Input: the secure response message containing the communication control policy and identifiers from Step 8.
Processing: the terminal performs decryption, parsing, policy interpretation, and system configuration updates to translate response information into concrete communication behavior.
Output: an updated terminal communication state in which network access, addressing, and quality-of-service parameters are set according to the server's policy.

### Step 10

The server processes user-provided attribute information with a generative AI model using a prompt sentence and routes results to appropriate functions.
The server receives additional attribute information and free-form text from the user, constructs a prompt sentence that encodes both the user's request and system context, and transforms this prompt sentence into a sequence of tokens. The server feeds these tokens into a generative AI model that outputs a structured instruction sequence. The server analyzes this instruction sequence to determine which information processing functions or organizational functions should handle the request and assigns routing labels or target identifiers accordingly.
Input: user attribute information and free-form text describing a request, together with current context such as device type, location, and emotional state when available.
Processing: the server performs text normalization, prompt sentence construction, tokenization, neural network inference using the generative AI model, and interpretation of the generated instruction sequence to map high-level user intent to specific system functions.
Output: routing directives and function selections that determine how subsequent information from the user and the terminal is processed within the system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer systems that manage identifiers for users, devices, and networks suffer from several technical limitations. First, such systems often rely on network-layer addressing, dynamic address translation, or relay devices to distinguish entities, which leads to ambiguity and instability of identifiers when devices move across networks, operate behind address translation devices, or change network configurations. As a result, backend computer systems frequently cannot maintain a persistent and globally unique mapping between real-world entities and digital identifiers without complex, stateful tracking mechanisms.

Second, existing identification frameworks generally treat network attributes, device attributes, and location attributes as separate, loosely coupled pieces of information. This separation prevents the processing hardware from generating a canonical representation of an event environment that can be deterministically and reproducibly converted into a unique identifier. When identification is based on partial or inconsistent data, backend logic must perform additional database joins and heuristic matching, which increases computational load, degrades latency, and complicates system design.

Third, conventional systems rarely incorporate automated collision detection and resolution at the level of hash-based identifiers derived from combined network, device, and location information. Without a systematic mechanism for detecting collisions and regenerating identifiers, systems risk associating the same identifier with different entities or contexts, leading to data corruption, misrouting of service requests, and security vulnerabilities.

Fourth, in many environments, the generation and use of identification information are not integrated with advanced machine learning systems, such as generative AI models. As a result, the computer hardware is not configured to generate structured prompt sentences that accurately reflect the underlying event context, nor to route analysis results from generative AI models to appropriate processing modules. This lack of integration prevents the computing infrastructure from using AI-generated insights for automated service classification, dynamic workflow routing, or context-aware processing based on rich environmental data.

Fifth, existing systems generally do not leverage user acoustic information and emotional state analysis as first-class technical inputs to identification processes or prompt generation. As a consequence, network optimization, identifier generation, and context modeling remain insensitive to the user's emotional state, even though this state may indicate conditions such as frustration, urgency, or confusion that have direct implications for resource allocation, error handling, or quality-of-service adjustments. This gap limits the ability of the computer systems to adapt communication parameters and downstream processing in real time according to human-centric signals.

Accordingly, there is a need for an improved computer-implemented system and method that (i) acquires and normalizes network, device, and location information into a canonical data sequence; (ii) generates collision-resistant, globally unique identifiers by applying cryptographic hash functions to the canonical data sequence independently of relay devices; (iii) automatically detects and resolves collisions through re-hashing with controlled variation; (iv) generates and analyzes structured prompt sentences for generative AI models based on the canonical data sequence; and (v) optionally incorporates user acoustic information and recognized emotional state into both identifier generation and AI prompt processing. By addressing these issues at the level of processor configuration and data flow design, the invention aims to improve computer technology itself, including identifier management, network communication behavior, and AI-assisted routing within distributed information processing environments.

The specific processing by the specific processing unit 290 of the data processing device 12 in Example 2 is realized by the following means.

The present invention provides a server comprising a processor configured to acquire and analyze information from information sources on an information network, the information including communication information, apparatus information, and location information, in order to identify identification information assigned globally; to receive user information including apparatus identification information and location information from a terminal; to integrate the user information with the information acquired from the information sources to generate a normalized data sequence representing environmental information related to an event; to combine network identification information, apparatus identification information, and location coordinate information included in the normalized data sequence in a predetermined order and format; to generate unique identification information that does not require traversal of a relay device by calculating a fixed-length hash value using a cryptographic hash function; to store, in a storage device, a correspondence between the unique identification information and the normalized data sequence; to reuse the same unique identification information for an identical normalized data sequence and ensure uniqueness for different normalized data sequences by performing collision detection and re-hashing processing; and to generate and analyze a prompt sentence based on user information or the normalized data sequence, instruct that the prompt sentence be output as an input to a generative AI model, and sort the unique identification information and related information to predetermined business functions or processing functions based on an analysis result from the generative AI model. This enables the server to implement, in hardware and software, an improved mechanism for deterministically generating globally unique, context-aware identifiers independent of network relay devices, to maintain a consistent mapping between normalized event environments and identifiers through automated collision management, and to tightly integrate these identifiers with generative AI-driven analysis and routing, thereby enhancing the efficiency, reliability, and adaptability of computer-based identification, communication, and service orchestration.

The term “system” refers to a combination of one or more computing devices, storage devices, communication interfaces, and software components that cooperate to perform the claimed processing.

The term “processor” refers to one or more hardware processing units, such as a central processing unit, a microcontroller, or a processing core, configured to execute instructions to perform the claimed functions.

The term “information source” refers to any data-providing resource accessible via an information network, including databases, directory services, logging systems, and application programming interfaces that supply communication information, apparatus information, or location information.

The term “information network” refers to a communication infrastructure that interconnects computing devices and information sources, including local area networks, wide area networks, and global packet-switched networks.

The term “communication information” refers to data that characterizes communication sessions or communication endpoints, including network addresses, protocol information, routing data, and connection metadata.

The term “apparatus information” refers to data that characterizes a computing or communication device, including device identifiers, hardware attributes, software attributes, and configuration parameters.

The term “location information” refers to data that indicates a physical or geographical position, including coordinates, region identifiers, address information, and location-related metadata.

The term “identification information assigned globally” refers to identification information that is intended to uniquely distinguish entities across multiple networks or domains, rather than being limited to a single local network.

The term “user information” refers to data received from a terminal that is associated with a user or a user's device, including apparatus identification information, location information, and optionally additional contextual or behavioral attributes.

The term “terminal” refers to an endpoint device operated directly or indirectly by a user, including computing devices, communication devices, and user interface devices capable of sending user information to the server.

The term “apparatus identification information” refers to data that uniquely or semi-uniquely identifies a device, including hardware identifiers, software-generated identifiers, and application-level identifiers.

The term “normalized data sequence” refers to a structured representation of environmental information, generated by integrating and formatting heterogeneous input data into a canonical order, syntax, and encoding suitable for deterministic processing.

The term “environmental information related to an event” refers to combined context data describing conditions under which a particular event occurs, including network attributes, device attributes, location attributes, temporal attributes, and optionally user-related attributes.

The term “network identification information” refers to data that identifies a communication network or network segment, including network identifiers, autonomous system identifiers, domain-related identifiers, or other network-level descriptors.

The term “location coordinate information” refers to structured numerical data representing a position in a coordinate system, including latitude and longitude values or equivalent coordinate sets.

The term “predetermined order and format” refers to a fixed, predefined arrangement and encoding rule for placing and representing multiple data fields, such that identical input values always yield the same combined representation.

The term “relay device” refers to an intermediate communication device that forwards data between networks or segments, including routers, gateways, and devices that perform network address translation.

The term “unique identification information” refers to identification information generated such that, within the operational parameters of the system, each distinct normalized data sequence corresponds to a single identifier and different normalized data sequences are not intentionally assigned the same identifier.

The term “cryptographic hash function” refers to a deterministic mathematical function that maps input data of arbitrary length to a fixed-length output, designed with properties including preimage resistance, second-preimage resistance, and collision resistance.

The term “fixed-length hash value” refers to a bit string of predetermined length produced by a cryptographic hash function, used as or within unique identification information.

The term “storage device” refers to a hardware component or subsystem capable of retaining digital data, including volatile memory, non-volatile memory, and external storage systems.

The term “correspondence” refers to an association maintained by the system between a normalized data sequence and the unique identification information generated from that sequence.

The term “collision detection” refers to a process by which the system determines that a candidate unique identification information value is already associated with a different normalized data sequence.

The term “re-hashing processing” refers to a process of modifying input data or parameters and recomputing a cryptographic hash function to obtain a different hash value when a collision is detected.

The term “prompt sentence” refers to a structured textual input prepared for a generative AI model, designed to instruct or guide the model's processing and output generation.

The term “generative AI model” refers to a machine learning model configured to receive prompt sentences and to produce generated content or analysis results, based on learned patterns from training data.

The term “business function” refers to a logically defined operational function of an organization, such as service handling, customer support, or workflow processing, that consumes or processes information managed by the system.

The term “processing function” refers to a computational operation or module executed by hardware and software components of the system, including classification, routing, transformation, and analysis of data.

The term “acoustic information” refers to audio signals or audio-derived data captured from a user, including speech signals, non-speech sounds, and their processed representations.

The term “signal processing technology” refers to algorithms and techniques applied to acoustic information or other signals to extract features, classify patterns, or infer states, including time-domain and frequency-domain processing.

The term “emotional state” refers to an inferred condition of a user's affective status, such as stress level, frustration, satisfaction, or urgency, determined based on acoustic information or other input signals.

The term “communication parameters” refers to configuration values that control communication behavior, including bandwidth allocation, latency optimization settings, priority levels, and quality-of-service parameters.

The term “communication conditions” refers to operational characteristics of a communication environment experienced by a user or device, including throughput, delay, reliability, and perceived quality of service.

The term “setting result of the communication parameters” refers to the actual configuration values or state determined by the system for communication parameters, which may be included in the normalized data sequence.

In one embodiment, a server, a terminal, and a user cooperate to implement the invention using general-purpose computing hardware and specific software components configured to perform the claimed processing.

The server uses one or more information processing devices, such as a rack-mounted computer including a multi-core central processing unit, semiconductor main memory, non-volatile storage, and a network interface controller. The server executes an operating system such as a server-oriented operating system and runs application software implemented using a server-side framework such as a web application framework. The server accesses one or more data management systems such as a relational database management system or a document-oriented database, and uses cryptographic libraries such as a standard cryptography library to compute cryptographic hash values. The server may use a reverse proxy or HTTP server to terminate secure connections from the terminal.

The terminal uses a computing device such as a smartphone, tablet, laptop, or dedicated terminal device equipped with a central processing unit, volatile and non-volatile memory, a wireless or wired communication interface, and optionally a position detection unit such as a global positioning system receiver and a microphone. The terminal executes an operating system such as a mobile operating system or desktop operating system and runs an application that communicates with the server and provides a user interface to the user.

The user operates the terminal by interacting with an application program. The user may provide explicit input, such as text, taps, or voice, and the user may carry or place the terminal such that the terminal can obtain device identifiers and location information relevant to the user's current environment.

The server acquires communication information, apparatus information, and location information from external information sources over an information network. The server uses a database client library or an HTTP client library to transmit structured queries or requests to external resources such as IP-to-location databases, network registries, or configuration repositories. The server receives response data including network-level identifiers, geographic regions, and device-related records, and stores such data in a structured form in a data store. The server thereby obtains, for each observed communication, the external context necessary to identify identification information assigned globally.

The terminal acquires apparatus identification information from operating system services. The terminal reads, for example, a device identifier provided by the operating system, an application-generated identifier stored in secure storage, or a hardware identifier available through a system API. The terminal also acquires location information by invoking a location service. The terminal receives position estimates in the form of latitude and longitude, possibly with accuracy and timestamp metadata. The terminal may also collect additional attributes such as operating system version, device model, or application version.

The server receives user information from the terminal. The server accepts network requests through a communication interface and a web server module. The server reads structured data sent by the terminal, which includes at least apparatus identification information and location information. The server optionally combines this data with communication-layer metadata automatically available from the network stack, such as a source network address, protocol, and connection timestamp.

The server generates a normalized data sequence representing environmental information related to an event by integrating the user information with the information acquired from the external information sources. The server defines a canonical schema that includes fields such as network identification information, apparatus identification information, location coordinate information, time information, and optional attributes. The server maps raw input data to this schema, normalizes encodings (for example, by converting text to a fixed character set and formatting numerical values with a fixed precision), and arranges the fields in a predetermined order. The normalized data sequence is stored as a structured record in the server's memory or persistent storage. Because the normalized data sequence is canonical and deterministic, identical real-world conditions yield an identical data sequence, which is essential for stable identifier generation.

The server generates unique identification information that does not require traversal of a relay device by calculating a fixed-length hash value from the normalized data sequence using a cryptographic hash function. The server converts the normalized data sequence into a sequence of bytes, for example by serializing the ordered fields into a text string and encoding it using a fixed text encoding. The server feeds this byte sequence into a hash computation function such as a secure hash algorithm implementation. The server obtains a fixed-length hash value that serves as a candidate unique identifier. Because the hash function exhibits collision-resistant properties and operates on a carefully constructed canonical input, the probability that two distinct environments produce the same hash is extremely low.

The server stores a correspondence between the unique identification information and the normalized data sequence in a storage device. The server inserts a record in a database table or key-value store that associates the hash value with the underlying normalized data sequence and any relevant metadata. The server subsequently reuses the same unique identification information when an identical normalized data sequence is reconstructed. If the server detects that a candidate hash already exists in the storage device but is associated with a different normalized data sequence, the server performs collision detection and re-hashing processing. The server may, for example, append a collision counter, a random nonce, or a deterministic disambiguation value to the normalized data sequence, recompute the hash, and repeat the lookup until a unique association is obtained. This controlled collision management ensures that each normalized data sequence is mapped to a single identifier and avoids inadvertent merging of distinct contexts.

The server generates and analyzes a prompt sentence based on the user information or the normalized data sequence. The server prepares a textual description that contains key attributes such as network identification information, apparatus identification information, and location coordinate information, and may refer to the unique identification information. For example, the server may generate a prompt sentence such as:
“Given the device identifier ‘device-abc-123’, the network ID corresponding to an access point in Tokyo, and the GPS coordinates 35.6804, 139.7690, explain how the server generated the unique identification information using a cryptographic hash function, and determine which processing module should handle subsequent requests from this device.”

The server then submits this prompt sentence as input to a generative AI model. The generative AI model may be a neural network-based language model implemented as a sequence-to-sequence transformer architecture with multiple self-attention layers, trained using stochastic gradient descent on large corpora of text and structured records. The model uses embedded representations of tokens, positional encodings, and multi-head attention mechanisms to compute a probability distribution over output tokens conditioned on the input prompt.

The server configures the generative AI model with specific hyperparameters such as layer count, hidden dimension size, attention head count, and learning rate schedule during training. The model is trained by minimizing a loss function such as cross-entropy between predicted tokens and reference tokens, and the server or a training subsystem updates model weights using an optimization algorithm such as an adaptive gradient method. The model may additionally be fine-tuned on domain-specific data that include examples of mapping environmental information and unique identifiers to processing functions or service categories.

The server interprets the generated text from the generative AI model according to predefined parsing rules and classification criteria. The server may extract indicators such as recommended processing modules, priority levels, or category labels from the output, using pattern matching or a secondary lightweight classifier. The server then sorts the unique identification information and related information into predetermined business functions or processing functions implemented as software modules, such as logging subsystems, anomaly detectors, or resource allocation controllers. This routing is done automatically by the server based on the model's output, allowing dynamic and context-aware behavior without requiring static rule sets for every possible combination of environment data.

The user may provide acoustic information through the terminal. The terminal captures audio via a microphone and forwards digitized audio data to the server, or processes it locally to extract features such as spectral coefficients, pitch, and energy. The server can receive the audio data or derived features and apply signal processing algorithms such as Fourier transforms, filter banks, and statistical classifiers to recognize an emotional state of the user. The server uses machine learning methods or rule-based analysis to infer states such as frustration or stress from the acoustic patterns. The server may append the recognized emotional state as an attribute in the normalized data sequence or embed it within the prompt sentence sent to the generative AI model, allowing subsequent identifier generation and model analysis to account for human-centric context.

The server may further adjust communication parameters based on the recognized emotional state and network information contained in the normalized data sequence. The server can configure quality-of-service settings, bandwidth allocation, retry policies, or error-handling thresholds on associated network devices or software stacks. The server may include the resulting communication parameter settings in the normalized data sequence and feed that augmented sequence into the cryptographic hash function. By doing so, any changes to the communication environment that are intended to address the user's emotional state become part of the environmental context, and the unique identification information reflects these conditions. This linkage improves the coherence between network behavior and identifier semantics and reduces ambiguity when analyzing logs and events across time.

The terminal uses the unique identification information received from the server to tag subsequent communications. The terminal may place the identifier in a header field of application-level messages or include it in request bodies. The server and other backend components use this identifier to quickly and reliably associate incoming communications with the correct normalized data sequence and stored context, without needing to repeat complex lookups based on changing network addresses or volatile device attributes. This reduces the number of database operations and heuristic matching steps needed to maintain state across distributed systems, improving throughput and latency.

The user benefits from more stable and responsive service behavior because the server can recognize the user's device reliably across different network configurations, including when the device is behind relay devices such as routers that perform network address translation. The server avoids dependency on transient or private addresses and instead relies on the canonical, hashed identifier that combines multiple stable attributes.

The described configuration improves computer technology in several ways. Because the server constructs a canonical normalized data sequence before hashing, the server can use efficient key-based lookups in the storage device instead of performing multiple joins and pattern matches on raw, unstructured data, thereby reducing processor cycles and memory usage. The collision detection and controlled re-hashing process improves data integrity and reduces the likelihood of misrouting or data corruption, which in turn decreases error handling overhead.

By integrating the generative AI model with deterministic identifier generation, the server uses the model's high-dimensional pattern recognition capabilities to interpret complex context represented in the prompt sentence. The model transforms a compact textual encoding of the environment and identifier into routing decisions and explanatory text that would be infeasible to derive using simple rule-based logic. The model operates according to its learned parameters and does not merely automate a human operator's decision tree; instead, it uses vector representations and attention mechanisms to consider relationships across multiple context elements, such as network type, device type, location, and emotional state. This yields more accurate and adaptive classification of events, which reduces misclassification and reprocessing costs.

Because the server uses specific data structures, such as normalized data sequences with fixed field ordering and canonical encodings, and because the server applies specific algorithms, such as cryptographic hashing and neural sequence modeling, the processing is not limited to generic “data acquisition and display” but instead implements a concrete, non-conventional data handling pipeline. This pipeline is designed to increase the determinism, reproducibility, and security of identifier generation, while enabling advanced AI-based analysis to be tightly coupled with those identifiers.

In alternative embodiments, the server may use different cryptographic hash algorithms, as long as they satisfy required security properties. The server may change the schema of the normalized data sequence to include additional fields such as device sensor readings, application context, or network path signatures. The server may deploy the generative AI model locally on the same physical machine, on a separate accelerator-equipped device, or via a remote AI service. The model architecture may vary, for example by using encoder-only or decoder-only transformers, recurrent networks, or hybrid architectures, provided that the model accepts prompt sentences and generates text-based analysis results. The terminal may perform part of the normalization or feature extraction locally to reduce network load, and the server may offload emotional state estimation to a specialized module or co-processor optimized for signal processing.

In yet another embodiment, the server may use multiple generative AI models with different training objectives and select a model according to attributes in the normalized data sequence. For example, the server may use a model specialized in network diagnostics when the normalized data sequence indicates network anomalies, and a different model specialized in user experience analysis when the emotional state suggests dissatisfaction. The server may also maintain a cache of prompt sentences and corresponding model outputs to avoid recomputation and improve latency for repeated or similar contexts.

By combining structured normalization, cryptographic hashing, controlled collision handling, emotional state analysis, communication parameter adjustment, and transformer-based generative modeling in a cohesive architecture, the server, terminal, and user collectively implement a system that improves the functioning of the computer network and identification infrastructure itself. The system reduces ambiguity in entity recognition, accelerates routing and classification of events, and permits scalable, context-aware processing that would not be achievable through conventional manual workflows or simple automation of human tasks.

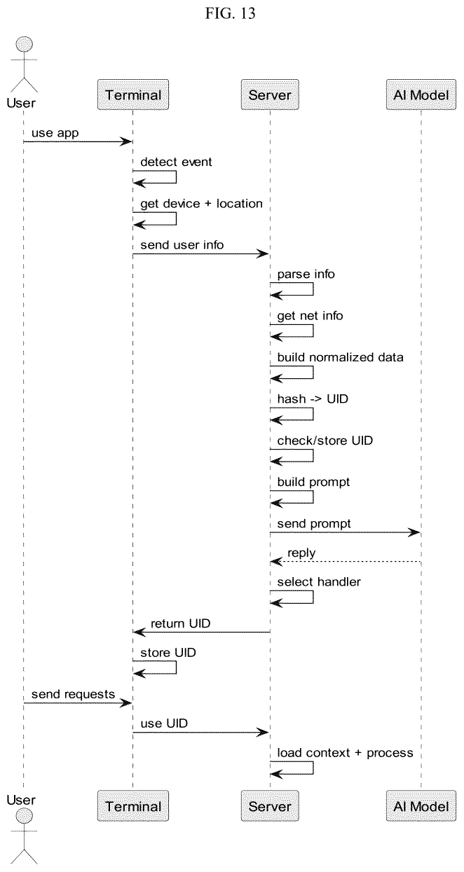

The following describes the processing flow using FIG. 13.

### Step 1

The terminal detects an event requiring identifier generation.
The terminal monitors its operating system APIs for events such as network connection establishment, application startup, or user login. As input, the terminal receives event notifications from the operating system, including information such as network connection state and application identifiers. The terminal evaluates these notifications and determines that a new or updated environment requires a unique identification information. As output, the terminal produces an internal trigger signal and an event context record indicating that device and location data collection should start.

### Step 2

The terminal collects apparatus identification information.
The terminal calls operating system services to obtain a device-specific identifier. As input, the terminal uses system APIs that expose device attributes, such as an OS-generated device ID, a hardware serial, or an application-level identifier stored in secure storage. The terminal reads these values, filters out unstable identifiers, and selects one or more identifiers to represent the device. The data processing includes validating the format, normalizing character encoding, and, if multiple identifiers exist, concatenating or hashing them into a single apparatus identification information value. As output, the terminal generates a canonical apparatus identification information string ready to be sent to the server.

### Step 3

The terminal collects location information and auxiliary context.
The terminal invokes a location service and, optionally, other sensor APIs. As input, the terminal uses signals from a global positioning system receiver, wireless access point information, or cellular network identifiers. The terminal computes or receives latitude and longitude values, accuracy measures, and timestamps. The terminal may also acquire auxiliary context such as the device model, operating system version, application version, and current time zone. The data processing includes averaging multiple location samples, rounding coordinates to a predetermined precision, and discarding outdated readings. As output, the terminal produces a structured set of location information and auxiliary context parameters.

### Step 4

The terminal assembles and transmits user information to the server.
The terminal constructs a request message that includes apparatus identification information, location information, and auxiliary context. As input, the terminal uses the canonical identifier string from Step 2 and the structured location/context data from Step 3. The terminal serializes these items into a structured payload, attaches metadata such as a local timestamp, and opens a secure network connection to the server. The data processing includes encoding text using a predetermined character set and compressing the payload if necessary. As output, the terminal sends a network request containing the user information to the server and records a local transaction ID for later correlation.

### Step 5

The server receives and parses user information.
The server accepts the incoming network request over a communication interface. As input, the server receives the payload sent by the terminal, including apparatus identification information, location information, and auxiliary context, along with implicit communication metadata such as source network address and transport protocol. The server passes the payload to an application layer that parses the structured data, validates field presence, and checks value ranges (for example, verifying that latitude and longitude fall within legal bounds). The data processing includes error detection, such as rejecting malformed fields or missing required attributes. As output, the server creates an internal event object containing verified user information and communication metadata.

### Step 6

The server acquires external communication and network information.
The server queries external information sources to enrich the event object. As input, the server uses the source network address, possible port numbers, and other connection parameters from Step 5. The server sends queries to one or more information sources, such as an IP-to-region database or a network registry, and receives records including network identification information, region codes, and provider codes. The data processing includes selecting the best-matching record, normalizing network identifiers into a canonical format, and discarding conflicting or incomplete entries. As output, the server augments the event object with communication information and network identification information.

### Step 7

The server integrates user information and external information into a normalized data sequence.
The server merges data fields into a canonical structure. As input, the server uses the enriched event object from Step 6, which contains apparatus identification information, location information, communication information, network identification information, and auxiliary context. The server orders the fields according to a predefined schema, converts numeric values to fixed-precision strings, and ensures a consistent field delimiter scheme. The data processing includes constructing a deterministic representation, such as “network_id|device_id|latitude|longitude|timestamp|region_code|aux_flags”. As output, the server produces the normalized data sequence as a single structured record and a serialized string representation suitable for hashing.

### Step 8

The server computes a candidate unique identification information using a cryptographic hash function.
The server applies a cryptographic hash algorithm to the serialized normalized data sequence. As input, the server uses the byte representation of the normalized data sequence from Step 7. The server initializes a hash context in a cryptographic library, updates the context with the input bytes, and finalizes the computation to obtain a fixed-length hash value. The data processing involves block-wise compression and mixing operations defined by the hash algorithm, which transform arbitrary-length input into a collision-resistant output. As output, the server generates a candidate unique identification information in the form of a fixed-length hash string associated with the current event.

### Step 9

The server checks for collisions and ensures identifier uniqueness.
The server verifies that the candidate hash does not conflict with existing records. As input, the server uses the candidate unique identification information from Step 8 and the normalized data sequence from Step 7. The server performs a lookup in its storage device, searching for records keyed by the candidate hash. If no record is found, the server accepts the candidate as a new unique identifier. If a record exists, the server compares the stored normalized data sequence with the current one. The data processing includes a field-by-field comparison to detect whether the two sequences are identical. As output, the server either confirms the candidate as valid (if sequences match) or flags a collision (if sequences differ).

### Step 10

The server resolves collisions through controlled re-hashing.
The server generates a modified input when a collision is detected. As input, the server uses the normalized data sequence and a collision indicator from Step 9. The server appends a collision-resolving element, such as a sequence counter or deterministic nonce, to the normalized data sequence string, and recomputes the cryptographic hash as in Step 8. The data processing repeats the hashing and lookup procedure until no conflicting association is found in the storage device. As output, the server produces a final unique identification information that is guaranteed to have a one-to-one correspondence with the augmented normalized data sequence.

### Step 11

The server stores the mapping between the normalized data sequence and the unique identification information.
The server records the association in persistent storage. As input, the server uses the final unique identification information from Step 10 and the normalized data sequence from Step 7, possibly including collision-resolving elements. The server constructs a database record with fields such as the identifier, canonical data fields, timestamps, and usage counters. The data processing includes creating an index on the identifier field to support fast lookups and committing the record in a transactional manner. As output, the server maintains a durable mapping that can be retrieved in future sessions to re-identify the same environment without recomputing the full context.

### Step 12

The server generates a prompt sentence for a generative AI model.
The server constructs a textual prompt that describes the current context. As input, the server uses the normalized data sequence, the unique identification information, and optionally additional attributes such as user category or service type. The server selects relevant fields, converts them into human-readable phrases, and assembles them into a complete sentence or paragraph. The data processing includes inserting dynamic values into a template and ensuring that the prompt follows a structure understandable by the generative AI model. As output, the server produces a prompt sentence such as:
“Given the device identifier ‘device-abc-123’, the network identifier corresponding to a network in Tokyo, the coordinates 35.6804, 139.7690, and the unique identification information ‘f3a9c7. . . ’, determine the appropriate processing module for future communications from this device and explain the reasoning.”

### Step 13

The server submits the prompt sentence to the generative AI model and interprets the result.
The server sends the prompt to a generative AI model and processes the returned text. As input, the server uses the prompt sentence from Step 12. The server encodes the text into tokens, transmits it to the generative AI subsystem, and receives an output sequence of tokens representing a generated answer. The data processing includes decoding the tokens back into text, then extracting structured information such as recommended processing module, priority level, or diagnostic flags using predefined parsing rules. As output, the server obtains classification or routing decisions derived from the generated text.

### Step 14

The server routes the unique identification information and context to appropriate processing functions.
The server uses the interpreted model output to direct internal modules. As input, the server uses the routing decisions and annotations obtained in Step 13 along with the unique identification information and normalized data sequence. The server selects one or more processing functions, such as logging, anomaly analysis, or resource allocation, and forwards the identifier and associated context to those functions via inter-process communication or internal function calls. The data processing includes constructing internal messages or task descriptors and updating system state to reflect the new routing assignments. As output, the server initiates specialized handling for the event under the selected processing functions.

### Step 15

The server generates a response message containing the unique identification information.
The server prepares a response to the terminal acknowledging identifier creation. As input, the server uses the final unique identification information from Step 10 and any additional status information such as creation time or validity indicators. The server constructs a response object, encodes it into a format suitable for transmission, and attaches appropriate status codes. The data processing includes serializing the identifier, applying any necessary compression, and encrypting the message at the transport layer. As output, the server transmits a response message containing the unique identification information back to the terminal.

### Step 16

The terminal receives, stores, and applies the unique identification information.
The terminal processes the server's response and updates local configuration. As input, the terminal receives the response message containing the unique identification information from Step 15. The terminal decodes the message, validates that it matches the original request using the local transaction ID, and extracts the identifier. The data processing includes writing the identifier to secure storage, updating in-memory configuration, and marking the identifier as active for current and future sessions. As output, the terminal obtains a persistent unique identification information value that it can attach to subsequent communication requests, enabling the server to recognize the device and its environment efficiently.

### Step 17

The user interacts with applications that utilize the unique identification information.
The user continues normal operation of applications on the terminal. As input, the user generates actions such as opening services, sending requests, or speaking commands. The terminal attaches the stored unique identification information from Step 16 to outgoing communication messages as part of headers or payloads. The data processing in the terminal includes inserting the identifier into each relevant request and managing lifetimes or refresh policies as needed. As output, the user's communications carry a stable, context-derived identifier that allows the server to quickly retrieve the corresponding normalized data sequence and apply appropriate processing paths determined in previous steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional networked information processing systems suffer from several technical limitations when generating and managing identification information and controlling communication quality. First, identification information such as addresses or tokens is typically generated from static device attributes or preconfigured pools without incorporating rich contextual data. As a result, such identifiers are not optimized for specific communication scenarios and cannot dynamically reflect user state or current network performance, which leads to suboptimal routing, quality of service, and resource allocation at the network level.

Second, emotion recognition and user state estimation, when present at all, are often implemented as separate application-layer functions. These functions may influence user interface behavior, but they are not structurally integrated into the low-level mechanisms by which identifiers are generated and network control parameters are set. Consequently, existing architectures cannot systematically adjust network paths, bandwidth allocation, or latency control based on a user's emotional state, and thus cannot reduce failure rates or delays in latency-sensitive processes such as electronic payments, public wireless access, or in-vehicle information services.

Third, while generative artificial intelligence models have recently become available as powerful analysis tools, conventional systems treat such models as ad hoc advisory components. There is no standardized mechanism to generate structured prompt sentences from system telemetry, feed them into a generative model, and then feed back the model's recommendations into the core logic for identifier generation, emotion handling, and network policy configuration. Without such a mechanism, the system cannot continuously optimize its own technical behavior based on actual historical performance, and cannot adapt the mapping between emotional states, identifiers, and communication quality control in a principled and automated manner.

Fourth, typical classification and routing of user inquiries or requests toward appropriate services or processing departments are implemented through static rule sets or manually maintained decision trees. These approaches do not fully exploit correlations among global identification information, device-specific context, emotional state, and network performance metrics. As a result, routing accuracy and responsiveness are limited, and the communication environment cannot be holistically controlled together with service-side processing behavior.

Accordingly, there is a need for an improved computer-implemented system and server architecture that (i) acquires and analyzes global identification information and device context, (ii) generates unique identification information that can encode emotion-dependent priority, (iii) structurally integrates emotion recognition into identification generation and network control, and (iv) uses generative artificial intelligence models, driven by systematically constructed prompt sentences, to refine the correspondence rules among emotional states, identifiers, and communication quality control based on historical performance data. By addressing these technical problems, the invention seeks to improve the operation of computers and networks themselves, resulting in more efficient, adaptive, and reliable communication environments.

The specific processing by the specific processing unit 290 of the data processing device 12 in Application Example 2 is realized by the following means.

The present invention provides a server comprising a processor configured to acquire and analyze information from information storage resources on an information network in order to identify globally assigned identification information; to receive device information including device identification information and location information from an information terminal and apply a cryptographic transformation process to input information including the device information, time information, and usage context information to generate unique identification information that does not require cross-network communication or address translation; to acquire user audio information, convert the user audio information into character information by audio signal processing and language analysis processing, and determine a user emotional state by emotion recognition processing; to generate emotion-linked identification information by encoding emotion-dependent priority information into the unique identification information or a communication path identifier on the basis of the device information and the emotional state, and to record an association between the emotion-linked identification information and communication quality control information; to generate a prompt sentence that instructs a generative artificial intelligence model to execute analysis processing, request estimation of optimization policies from the generative artificial intelligence model using historical information including the emotion-linked identification information, the communication quality control information, and past communication performance information, and update correspondence rules among emotions, identification information, and communication quality control on the basis of a response from the generative artificial intelligence model; to receive inquiry information or request information from a user and generate and analyze a prompt sentence that instructs the generative artificial intelligence model to execute analysis processing on the basis of the inquiry information or the request information and the correspondence rules; and to classify the inquiry information or the request information into a service function or a processing department on the basis of an analysis result and the correspondence rules, and control a communication environment by setting or updating communication control conditions of a network control apparatus. This enables the computer-implemented system to technically improve identifier generation and network control by embedding emotion-dependent priority into unique identification information, by dynamically adjusting communication quality parameters in response to recognized emotional states, and by continuously optimizing correspondence rules among emotional states, identifiers, and communication quality control through machine-generated prompt sentences and generative artificial intelligence analysis, thereby providing more efficient, adaptive, and reliable communication processing than conventional architectures.

The term “processor” refers to a hardware or virtual computation element, such as a central processing unit or a processing core of an information processing apparatus, configured to execute instructions that realize the functions described in the present disclosure.

The term “information storage resource” refers to any data storage facility accessible via an information network, including but not limited to remote databases, directory services, and distributed storage systems, that store globally assigned identification information or related metadata.

The term “information network” refers to a communication infrastructure, such as a packet-switched network or the Internet, that enables transmission and reception of data between the server, information terminals, and information storage resources.

The term “globally assigned identification information” refers to identification data that is assigned according to a global or wide-area addressing or naming scheme, and that is capable of uniquely identifying an entity such as a device, node, or user across multiple networks or domains.

The term “information terminal” refers to any user-side or client-side computing apparatus, such as a mobile communication apparatus, a vehicle-mounted apparatus, or a general-purpose computing apparatus, that acquires user or device information and communicates with the server.

The term “device information” refers to data that characterizes an information terminal or communication device, including but not limited to device identification information, hardware attributes, software configuration, and operational status.

The term “device identification information” refers to an identifier that uniquely or quasi-uniquely represents a device within at least a given network scope, such as a media access control address, a device serial identifier, or a network interface identifier.

The term “location information” refers to data indicative of a spatial position of an information terminal or device, such as geographic coordinates, position estimates derived from wireless signals, or region identifiers.

The term “time information” refers to data representing a temporal point or interval, such as a timestamp, time window, or duration, that can be associated with generation or use of identification information.

The term “usage context information” refers to information indicating a situation or scenario in which a device or user is operating, such as a type of service being accessed, a class of application, or an operational mode of a system.

The term “cryptographic transformation process” refers to a computational procedure that applies a cryptographic algorithm, such as a hash function or encryption function, to input data in order to generate a transformed output with properties such as collision resistance or non-reversibility.

The term “unique identification information” refers to an identification value generated by the processor that is intended to be unique within a prescribed scope, and that can be used to distinguish a device, session, or communication flow without requiring cross-network communication or address translation.

The term “user audio information” refers to digital data representing sound produced by a user, acquired by an input device such as a microphone, and suitable for processing by audio signal analysis and speech recognition algorithms.

The term “audio signal processing” refers to computational operations applied to audio information, including filtering, feature extraction, segmentation, and noise reduction, to prepare the audio information for further analysis or recognition.

The term “language analysis processing” refers to computational processing that operates on linguistic data, such as speech recognition, tokenization, syntactic analysis, or semantic analysis, to convert audio or text into structured language information.

The term “character information” refers to textual data representing spoken content or other user input in a character-based form, such as a string of alphanumeric symbols or encoded natural language text.

The term “emotion recognition processing” refers to computational processing that estimates a user's emotional state by analyzing audio information, character information, or derived features, using techniques such as pattern recognition, machine learning, or statistical modeling.

The term “user emotional state” refers to a condition of a user inferred by emotion recognition processing, such as calmness, stress, impatience, tension, fatigue, or other affective states, often represented as labels or numerical scores.

The term “emotion-linked identification information” refers to identification information in which emotion-dependent priority information or classification information is encoded, such that the identification information reflects both device context and a current or recent user emotional state.

The term “communication path identifier” refers to data that designates a communication route or flow within a network, such as an address, label, or token used by a routing or switching mechanism to distinguish a particular communication path.

The term “emotion-dependent priority information” refers to data that specifies a priority level or class for network processing, wherein the priority is determined at least partially on the basis of an estimated user emotional state.

The term “communication quality control information” refers to control parameters, such as bandwidth allocation, delay constraints, loss tolerance, or priority class, that influence the quality of service applied to communication flows.

The term “association” refers to a stored relationship between two or more items of data, such as a mapping or correspondence between identification information and communication quality control information.

The term “prompt sentence” refers to machine-processable textual content provided as an input to a generative artificial intelligence model, the content specifying an instruction, context, or query that guides the model's analysis or generation behavior.

The term “generative artificial intelligence model” refers to a computational model, such as a machine learning model trained on large-scale data, that is capable of generating or transforming information, including text, in response to input data such as prompt sentences.

The term “optimization policy” refers to a set of rules, parameters, or guidelines that define how a system should adjust its processing, including identifier generation and communication quality control, in order to improve performance metrics.

The term “historical information” refers to stored data representing past system behavior, including previously generated identification information, communication quality control information, and communication performance information, used to refine future operation.

The term “communication performance information” refers to measured or derived metrics representing the quality of past or current communications, such as latency, throughput, error rate, or success rate of transactions.

The term “correspondence rules” refers to logical relationships or mapping definitions that specify how emotional states, identification information, and communication quality control information should be associated and used together in system processing.

The term “inquiry information” refers to information expressing a user's question, problem, or request for assistance, typically provided in natural language via an information terminal.

The term “request information” refers to information indicating a user's request for execution of a process, access to a service, or initiation of a communication, transmitted from an information terminal to the server.

The term “service function” refers to a processing function or capability provided by a system, such as a support service, transaction service, or communication service, that handles user inquiries or requests.

The term “processing department” refers to a logical or organizational unit, such as a functional group or processing class within a system, that is designated to handle certain categories of inquiries, requests, or tasks.

The term “communication environment” refers to technical conditions under which data is transmitted between endpoints, including available bandwidth, routing paths, latency characteristics, and priority controls.

The term “communication control condition” refers to a configuration parameter or set of parameters that defines how a network component should handle specific communication flows, including aspects of scheduling, routing, and resource allocation.

The term “network control apparatus” refers to a network-side control component, such as a network controller, router controller, or management server, that applies communication control conditions to manage traffic in a network.

The term “network management apparatus” refers to a management component or system that maintains configuration, policy, and status information for network elements, and that may store associations between identification information and communication quality control information.

The term “bandwidth allocation information” refers to data specifying an amount or proportion of communication capacity that should be reserved or made available for a particular communication path or class of traffic.

The term “delay control information” refers to data defining constraints or preferences regarding latency or jitter for a communication path, such as maximum acceptable delay or priority for low-latency routing.

The term “priority information” refers to data indicating a relative processing importance of communication flows, such as priority levels or classes used by scheduling and queuing mechanisms.

The term “electronic payment process” refers to a transaction process in which payment information is exchanged electronically between a user and a payment service, and that relies on network communication for authorization and completion.

The term “public wireless access process” refers to a connection process in which a user terminal establishes access to a publicly available wireless communication service, such as a shared wireless access point.

The term “mobile-body information provision process” refers to a process in which information services, such as entertainment or navigation data, are provided over a network to a terminal installed in or carried by a moving object.

In one embodiment, a server, a terminal, and a user cooperate to implement a system that generates emotion-linked identification information and controls a communication environment based on such identification information. The server includes a processor, a memory, one or more network interfaces, and optionally an interface to one or more network control apparatuses. The terminal includes a processor, a memory, a network interface, a microphone, and optionally position detection hardware such as a satellite positioning module or a wireless positioning module.

The server executes software modules including an identification information management module, a cryptographic transformation module, an emotion analysis module, a correspondence rule management module, a generative AI interaction module, and a network control interface module. The terminal executes software modules including a device information acquisition module, a location information acquisition module, an audio acquisition module, a speech-to-text conversion module, and an application control module.

The terminal acquires device identification information by using an operating system level network interface. For example, the terminal acquires a media access control address or other hardware-level identifier from the network interface controller via a system application programming interface. The terminal acquires location information by using an operating system location service that combines data from positioning hardware and wireless infrastructure. The terminal stores the device identification information and the location information in a structured data record in its memory.

The terminal acquires user audio information by using the microphone and an audio input driver. The terminal samples an analog audio signal at a prescribed sampling frequency and converts the audio into digital audio frames stored in a circular buffer in memory. The terminal optionally applies audio signal processing such as noise reduction and normalization in the time or frequency domain. The terminal then performs speech-to-text conversion. In one example, the terminal uses a local speech recognition library that performs feature extraction (for example, mel frequency cepstral coefficient extraction) and acoustic modeling using a neural-network-based acoustic model. In another example, the terminal sends compressed audio frames to a remote speech recognition service via Hypertext Transfer Protocol Secure, and receives a character-based transcript.

The server receives from the terminal a data structure that includes the device identification information, the location information, time information, usage context information, and the transcript derived from the user audio information. The server stores this data structure in a memory or a storage device in association with a request identifier. The server validates the format of each field and rejects malformed or inconsistent data, thereby preventing unnecessary processing and reducing computational load.

The server generates unique identification information by applying a cryptographic transformation process to selected fields of the data structure. The server concatenates the device identification information, location information, time information, and usage context information in a deterministic order and converts the concatenated data into a byte array. The server applies a cryptographic hash function, such as a 256-bit hash function, to the byte array. The server obtains a fixed-length digest and maps predetermined bit ranges of the digest to an identification information format, for example an address format with a prefix and a host portion. The server thereby generates unique identification information that is collision-resistant within the intended address space and does not require network address translation when used as an address.

The server determines a user emotional state by using an emotion analysis module. In one embodiment, the server uses a neural-network-based classifier that operates on text features derived from the transcript. The server converts text into feature vectors by applying tokenization, embedding lookup, and context encoding. For example, the server uses a recurrent or transformer-type neural network with multiple layers, where each layer comprises a plurality of nodes with learned weights. The server feeds the feature vectors into the neural network and obtains output values representing probabilities of predefined emotional categories such as calmness, stress, impatience, tension, and fatigue. The server selects an emotional category whose probability exceeds a threshold, and outputs that category as the user emotional state.

The server trains the emotion analysis module in advance using supervised learning. The server prepares a training dataset including pairs of text strings and labeled emotional categories. The server defines a loss function such as cross-entropy between predicted probabilities and true labels. The server initializes the neural network weights and repeatedly updates the weights by backpropagating gradients of the loss function and applying an optimization algorithm such as stochastic gradient descent or an adaptive gradient method. The server optionally performs data augmentation by altering word order, substituting synonyms, or injecting noise into training text to increase robustness. The server thereby improves classification accuracy and reduces error in emotional state estimation.

The server generates emotion-linked identification information by encoding emotion-dependent priority information into the unique identification information or a communication path identifier. The server assigns each emotional category to a priority level and a code pattern. For example, the server reserves several bits in the identification information or a header field of a communication path identifier for priority encoding. The server sets these bits according to the determined emotional state. The server stores in memory a correspondence table that associates emotional categories, priority codes, and communication quality control parameters such as bandwidth allocation, delay constraints, and queue priority levels.

The server maintains and updates correspondence rules among emotional states, identification information, and communication quality control by interacting with a generative AI model. The server selects historical records containing emotion-linked identification information, communication performance information, and previously applied communication quality control settings. The server aggregates these records into statistical summaries, such as average latency per emotional category and priority code, distribution of error rates, and resource utilization. The server constructs a prompt sentence that describes these summaries and explicitly requests suggestions for improving mapping between emotional categories and communication quality control parameters.

For example, the server generates a prompt sentence such as:
“The system currently generates identifiers using device identification, location, and timestamp, and encodes user emotion into a priority bit. Recent metrics show high latency for stressed users during electronic payment. Suggest an improved scheme to map emotions (stress, impatience, fatigue, calmness) to bandwidth allocation, delay constraints, and priority levels, and explain how to adjust bit assignments in the identifier.”

The server transmits this prompt sentence to a generative AI model deployed on a remote computing infrastructure or on a local accelerator device. The generative AI model is, for example, a transformer-type neural network with multiple attention layers and feed-forward sublayers, trained on a large corpus of technical text. The server sends the prompt sentence as a sequence of tokens, and the generative AI model outputs a sequence of tokens representing recommendations. The server converts the tokens back to text and parses the content to extract numerical or categorical configuration proposals, such as new priority levels, updated thresholds, or alternative bit layouts.

The server does not simply follow free-form text suggestions. The server uses a rule-based extractor that searches for patterns describing numerical ranges and conditional statements. The server compares extracted values against safety limits and applies only those recommendations that satisfy consistency checks. The server then updates internal correspondence rules by rewriting entries in configuration tables stored in memory. This process produces a non-conventional feedback cycle in which generative AI output directly modifies technical parameters controlling identifier structures and network quality control, in a manner that is systematically constrained and verifiable.

The server interacts with a network management apparatus or a network control apparatus to enforce communication quality control parameters. The server registers the emotion-linked identification information and the associated communication quality control parameters in a management database accessible by the network control apparatus. The server transmits configuration messages to the network control apparatus using a programmatic interface defined by the apparatus. The server configures bandwidth allocation, scheduling priority, and routing preferences for flows whose headers match the emotion-linked identification information or an associated communication path identifier.

When a user emotional state indicates tension, impatience, or fatigue, the server sets more aggressive delay constraints and higher scheduling priority for communication flows associated with the emotion-linked identification information. The network control apparatus, executing its control software, assigns such flows to higher-priority queues and shorter routing paths. As a result, network latency and jitter for these flows are reduced. The server thereby achieves a technical effect of lowering round-trip delays for sensitive communications such as electronic payment transactions and public wireless access authentications.

The terminal utilizes the emotion-linked identification information supplied by the server. The terminal embeds the emotion-linked identification information in protocol headers or in application-level tokens that are appended to requests destined to network services. The terminal adjusts application-level timeouts and retry strategies based on priority information. For instance, when the terminal receives priority information indicating a high-priority state, the terminal sets shorter application-level timeouts and more frequent retransmissions for payment authorization messages, which interacts with network-level prioritization to further reduce overall completion time.

The user interacts with the system by providing speech input and by initiating requests such as payment execution, network access, or information service consumption. The user may also submit natural language questions about system operation. When the user asks, for example, “How does this system generate a unique ID from my MAC address and location, and how does my emotion influence network speed?”, the terminal converts the speech to text and sends the text to the server. The server wraps the text into a prompt sentence, adds relevant technical context, and submits the prompt sentence to the generative AI model. The server receives an explanatory answer and returns it to the terminal for display, thereby improving transparency of the technical operation.

The system improves computer technology itself in several ways. The server introduces a non-standard data structure in which device context, location, time, and emotional state are all encoded into a single identification value or closely associated set of values. This structure allows network control apparatuses to execute efficient table lookups and priority decisions based solely on compact identifier fields, instead of requiring multiple independent databases or rule engines. Because the emotional state is encoded into bits of an identifier, a switching node can determine priority by a simple bitmask operation, reducing computational complexity and processing time compared to higher-layer semantic inspection.

The server also improves resource management by using historical performance information and generative AI-based optimization. Traditional systems rely on static, manually defined mappings between classes of users or services and quality control settings. By contrast, the server dynamically optimizes these mappings based on observed latency, error rates, and congestion metrics. The server uses a generative AI model to explore non-intuitive parameter combinations that human operators might not manually design. Since the server encodes mapping rules into configurable tables and verifies AI-derived proposals before application, the resulting adaptation is technically grounded and constrained, and leads to measurable improvements in processing speed and reliability.

The emotion recognition module improves accuracy by combining text-based features with contextual metadata. For example, the server augments text embeddings with additional features, such as time of day, terminal type, and previously detected emotions, and feeds this composite vector into the neural network. This multi-feature fusion reduces misclassification in borderline cases, which in turn reduces inappropriate prioritization or deprioritization. The reduction of misclassification directly lowers the rate of unnecessary network reconfigurations and contributes to communication stability.

The architecture also reduces communication load in certain scenarios. By assigning higher priority and more appropriate quality control only when emotional state and contextual usage justify it, the server avoids globally increasing priority for all traffic from certain devices or applications. This selective prioritization prevents unnecessary allocation of high-bandwidth queues and keeps the network in a more balanced state. Moreover, when historical performance information indicates that certain configurations do not improve outcomes, the generative AI-based optimization leads the server to reduce or remove ineffective rules, which eliminates redundant control traffic.

In an alternative embodiment, the server performs at least some emotion recognition locally at the terminal. The terminal executes a compact neural network for preliminary emotion classification using locally cached models. The terminal attaches a preliminary emotional category to its data structure, and the server refines the classification using a larger model. This division reduces uplink bandwidth and server-side computational cost. In another variation, the server uses an audio-based emotion classifier that operates on prosodic features such as pitch, energy, and speaking rate, using a convolutional-recurrent neural network. The server can combine text-based and audio-based outputs by applying a weighted decision rule, further improving accuracy.

In a further embodiment, the server applies the emotion-linked identification mechanism to mobile-body information provision processes, such as in-vehicle entertainment or navigation. The server encodes specific routing preferences into the identification information for traffic associated with a moving terminal. Network control apparatuses along a route of travel use these preferences to keep flows on. links with sufficient coverage and capacity. By dynamically adjusting these settings based on the emotional state of the user in the vehicle, the server reduces disruptions during critical navigation or communication periods.

The server also supports multiple generative AI models and alternative prompting strategies. In one variation, the server maintains a library of prompt templates, each specialized for optimizing different metrics such as latency, throughput, or fairness among users. The server selects a template according to current network objectives and fills variable fields with freshly computed statistics. Examples of prompt sentences include:
“Based on the following latency and loss statistics for each emotional category and priority level, propose updated bandwidth allocation ratios that minimize latency for stressed users while limiting throughput impact on calm users.”
“Given the current bit layout of our identifier and the distribution of emotional states across sessions, propose a revised bit allocation that reduces collision probability while preserving fast priority decoding at network devices.”

By using such structured prompt sentences, the server obtains targeted technical recommendations rather than general narrative text. The server's rule-based parser is specifically designed to interpret these targeted outputs and translate them into configuration table updates. This specialized interaction between the server and the generative AI model constitutes a non-conventional use of machine learning models focused on internal computer performance optimization, not merely on replacing human decision-makers.

Through these embodiments, the server, the terminal, and the user jointly realize a system in which unique identification information, emotional state, and communication quality control are tightly integrated at the technical level. The described data structures, neural network architectures, cryptographic processes, prompt sentence generation, and rule-updating mechanisms provide concrete procedures that a skilled person can implement using general-purpose computing hardware and communication infrastructure, and they result in improved processing speed, accuracy, and efficiency compared to conventional systems that do not encode emotional state into identification information or do not use generative AI models to optimize internal network control rules.

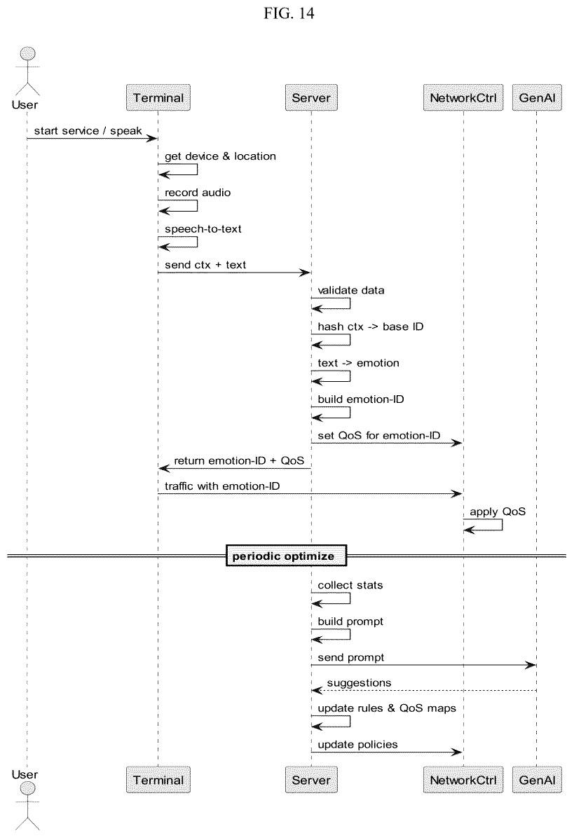

The following describes the processing flow using FIG. 14.

### Step 1

User initiates a service request.
User operates an application on the terminal to start a process such as network login, electronic payment, or an information service.
Input: A user action (for example, tapping a “Pay” button or opening a Wi-Fi login screen) and optional user speech (for example, “I am in a hurry and need to pay quickly”).
Output: A request context on the terminal indicating the requested service type (for example, “payment”, “public_wifi”, “vehicle_service”) and a trigger signal to start data acquisition.
Terminal interprets the user action through the application logic and creates an internal context object that records the service type, current time, and initial status flags.

### Step 2

Terminal collects device identification information.
Terminal queries an operating system network interface API to obtain device identification information such as a media access control address or a network interface identifier.
Input: A request from the application to the operating system for hardware-level identification.
Data processing: Terminal calls a system function that reads the identifier from the network interface controller, normalizes its format (for example, converting to lower-case and removing delimiters), and checks for validity.
Output: A normalized device identification string stored in a device information structure in terminal memory.

### Step 3

Terminal acquires location information.
Terminal uses a location service API that aggregates data from a positioning module and wireless base stations.
Input: A location request including desired accuracy and timeout, combined with current sensor readings (for example, GPS signals, Wi-Fi beacons, or cell tower IDs).
Data processing: Terminal fuses raw location signals, computes a current position estimate (latitude and longitude), and associates an accuracy radius with a timestamp.
Output: A location information object containing coordinates, accuracy, and timestamp, stored alongside the device identification information.

### Step 4

Terminal records user audio information.
Terminal activates the microphone through an audio input driver and records audio samples when the user speaks.
Input: An audio capture trigger from the application and an analog audio signal from the microphone.
Data processing: Terminal samples the analog signal at a specified sampling rate, quantizes it into digital samples, segments the samples into frames, and optionally applies pre-processing such as noise reduction and level normalization.
Output: A buffered digital audio signal stored in terminal memory, referenced by an audio session identifier.

### Step 5

Terminal converts user audio to textual character information.
Terminal uses a speech-to-text conversion module or a remote speech recognition service to convert the audio into text.
Input: The buffered digital audio signal and configuration parameters such as language and expected utterance length.
Data processing: Terminal extracts acoustic features (for example, mel frequency cepstral coefficients), feeds the features into an acoustic model, decodes phonetic sequences into words, and applies language modeling to select the most likely word sequence.
Output: A transcript string representing the user's speech, stored in a request data structure with the device identification information and location information.

### Step 6

Terminal creates a combined request payload.
Terminal assembles all collected information into a structured data record.
Input: The service context, device identification information, location information, time information, and transcript string.
Data processing: Terminal constructs a structured object (for example, a key-value structure) that includes all fields, verifies that mandatory fields are present, and encrypts the content for secure transmission.
Output: An encrypted request payload ready to be transmitted to the server via a network interface.

### Step 7

Server receives and validates the request payload.
Server listens on a network endpoint, accepts the incoming request from the terminal, and parses the payload.
Input: The encrypted request payload transmitted by the terminal over a network connection.
Data processing: Server decrypts the payload, verifies message integrity and authentication tokens, parses the structured fields (device identification, location, time, transcript, and service type), and performs schema validation and basic range checks.
Output: A validated internal request object stored in server memory, assigned with a unique request identifier.

### Step 8

Server generates base unique identification information using a cryptographic transformation.
Server applies a hash-based algorithm to create a unique identifier from core contextual data.
Input: The device identification information, location information, time information, and usage context information extracted from the request object.
Data processing: Server concatenates the inputs in a predetermined order, converts the concatenated string into a byte array, and applies a cryptographic hash function with a fixed output length. Server then slices the resulting digest into segments and maps those segments into a structured identifier format, such as an address with a prefix and host portion.
Output: Base unique identification information that is deterministic for the given inputs and collision-resistant within the defined space, associated with the request identifier.

### Step 9

Server determines a user emotional state from the transcript.
Server uses an emotion recognition module to classify the user's emotional state based on the textual content.
Input: The transcript string and optionally metadata such as time of day and service type.
Data processing: Server tokenizes the text, converts tokens into vector embeddings, and feeds the embeddings into a trained neural network (for example, a multi-layer transformer or recurrent network). The network outputs scores for predefined emotional categories. Server applies a softmax operation to normalize scores into probabilities, compares probabilities to thresholds, and selects the most probable emotional category.
Output: A user emotional state label (for example, “stress”, “impatience”, “fatigue”, or “calmness”) with associated confidence values, stored in the request object.

### Step 10

Server generates emotion-linked identification information.
Server encodes emotion-dependent priority information into the base unique identification information or into a separate communication path identifier.
Input: The base unique identification information and the user emotional state label.
Data processing: Server consults a correspondence table that maps emotional states to priority codes and network quality classes. Server reserves specific bit positions within the identifier or the communication path identifier and sets these bits according to the mapped priority code. Server ensures that reserved bits do not conflict with structural constraints of the identifier scheme.
Output: Emotion-linked identification information that embeds both device context and emotional priority, stored in an identification mapping table with the request identifier.

### Step 11

Server associates emotion-linked identification information with communication quality control parameters.
Server binds identification information to network behavior settings.
Input: The emotion-linked identification information and the priority code associated with the emotional state.
Data processing: Server retrieves default communication quality control parameters for the corresponding priority class, including bandwidth allocation, delay constraints, and queue priority. Server constructs a configuration entry that associates the emotion-linked identification information with these parameters and stores the entry in a configuration database or an in-memory policy table.
Output: An updated mapping between the emotion-linked identification information and communication quality control settings accessible to network control apparatuses.

### Step 12

Server prepares historical data for optimization.
Server collects past performance metrics for flows using emotion-linked identifiers.
Input: Historical records including identification information, applied communication quality control parameters, and measured communication performance (for example, latency and error rate).
Data processing: Server aggregates records by emotional category and priority level, computes statistical metrics such as mean latency, variance, and transaction success rate, and organizes the results into a human-interpretable summary.
Output: A summarized historical dataset ready for use in generating a prompt sentence to a generative AI model.

### Step 13

Server generates a prompt sentence for a generative AI model.
Server constructs a structured natural language instruction that encodes the optimization problem.
Input: The summarized historical dataset and current correspondence rules between emotional states, identifiers, and communication quality control parameters.
Data processing: Server inserts numerical and categorical values into a template, forming a coherent narrative that describes current behavior and observed issues. Server explicitly requests improvements to parameter mappings and identifier bit assignments.
Output: A prompt sentence such as “The system currently generates identifiers using device identification, location, and timestamp, and encodes user emotion into a priority bit. Recent metrics show high latency for stressed users during electronic payment. Suggest an improved scheme to map emotions (stress, impatience, fatigue, calmness) to bandwidth allocation, delay constraints, and priority levels, and explain how to adjust bit assignments in the identifier.”

### Step 14

Server requests optimization from a generative AI model.
Server sends the prompt sentence to a generative AI model hosted locally or remotely and receives suggested configuration changes.
Input: The prompt sentence and generative AI model parameters such as decoding strategy and maximum response length.
Data processing: Server transmits the prompt to the model via an application programming interface, waits for the model to process the text, and receives an output text that contains proposed rules, ranges, and mappings.
Output: A model response string containing candidate optimization strategies and concrete parameter suggestions.

### Step 15

Server parses and validates generative AI suggestions.
Server extracts machine-usable configuration data from the model response and checks consistency.
Input: The model response string.
Data processing: Server applies a parser that recognizes parameter patterns, units, and conditional statements, converts textual descriptions into numerical values and structured rules, and compares them against predefined safety and consistency constraints. Server discards or adjusts any values that violate physical or protocol limits.
Output: A set of validated configuration updates, including revised mapping tables and threshold values.

### Step 16

Server updates correspondence rules and configuration tables.
Server rewrites internal policy structures based on validated suggestions.
Input: The validated configuration updates and the current correspondence rules.
Data processing: Server modifies entries in rule tables that map emotional states to priority codes and communication quality control parameters, and adjusts bit assignments used in identifier encoding. Server maintains versioning metadata for rollback, and ensures that subsequent requests use the updated rules.
Output: Updated correspondence rules and configuration tables stored in persistent storage and loaded into runtime memory.

### Step 17

Server configures a network control apparatus with emotion-linked policies.
Server deploys the emotion-linked identification information and associated parameters to the network.
Input: The mapping entries linking emotion-linked identification information to communication quality control parameters.
Data processing: Server formats configuration messages that specify matching conditions on identification fields and associated actions (for example, priority queue assignment and bandwidth reservation). Server sends these messages to the network control apparatus via a control protocol interface and confirms successful application by checking response codes.
Output: An updated network control state in which flows matching the emotion-linked identification information are treated according to the specified quality control policies.

### Step 18

Terminal applies emotion-linked identification information in its communications.
Terminal incorporates the provided identification information into outgoing messages.
Input: A server response containing the emotion-linked identification information and an indication of priority class.
Data processing: Terminal stores the identification in its session context, inserts it into protocol headers or application-layer fields for all messages related to the active service, and adjusts application parameters such as timeouts and retransmission intervals according to the indicated priority.
Output: Outgoing communication flows that are marked with the emotion-linked identification information and tuned application behavior aligned with network-side prioritization.

### Step 19

Network control apparatus prioritizes flows based on emotion-linked identification information.
Network control apparatus receives traffic and applies control conditions configured by the server.
Input: Packets or messages tagged with emotion-linked identification information and local policy tables specifying corresponding control parameters.
Data processing: Network control apparatus matches identification fields against policy entries, assigns traffic to appropriate queues, adjusts scheduling weights, and selects routing paths that satisfy configured delay constraints and bandwidth allocations.
Output: Prioritized or otherwise adjusted forwarding behavior for flows associated with specific emotional states, resulting in different latency and throughput characteristics at the network level.

### Step 20

Server monitors performance and updates logs.
Server continuously observes network behavior and updates historical records.
Input: Runtime metrics from network control apparatuses and application servers, including latency, throughput, error counts, and completion times for flows with emotion-linked identifiers.
Data processing: Server correlates metrics with identification information and emotional states using logged request identifiers, updates historical datasets, and calculates new summary statistics. These updated records feed future optimization cycles.
Output: Refreshed historical information that reflects the actual impact of emotion-linked policies, enabling subsequent refinement via new prompt sentences and generative AI model interactions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

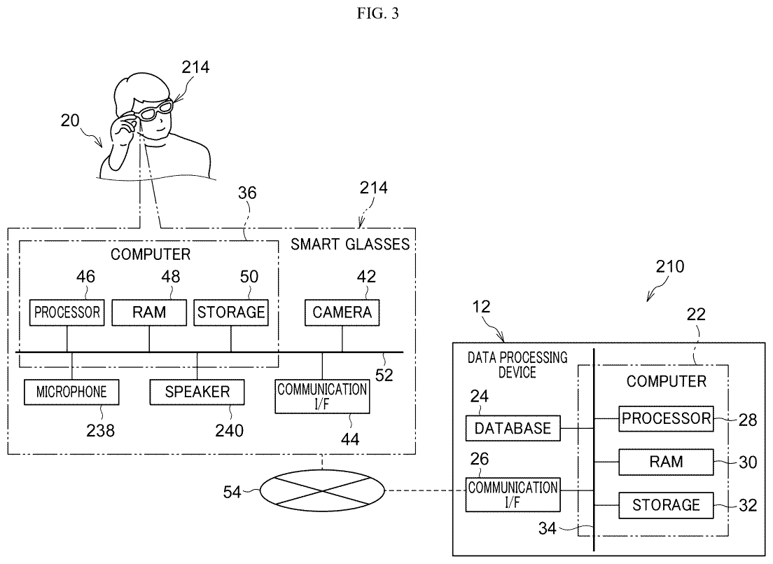

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

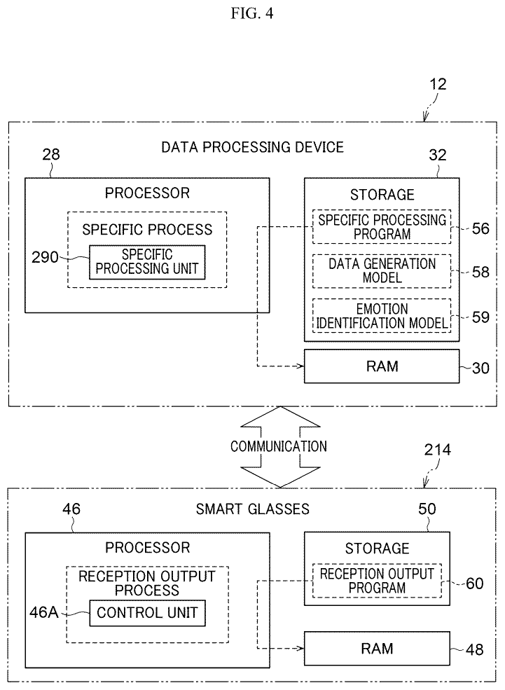

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

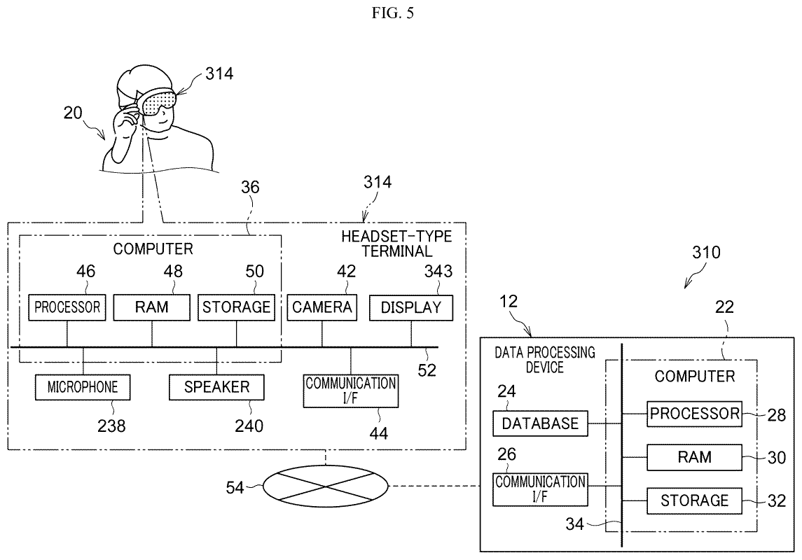

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

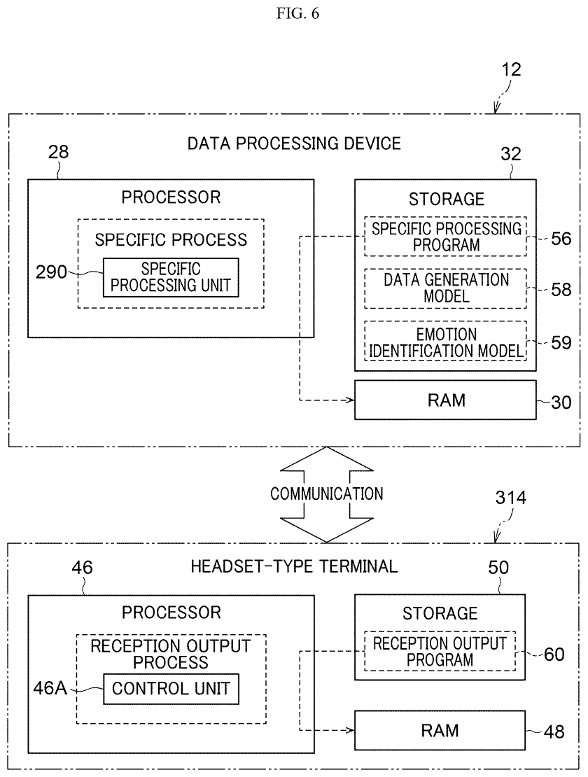

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

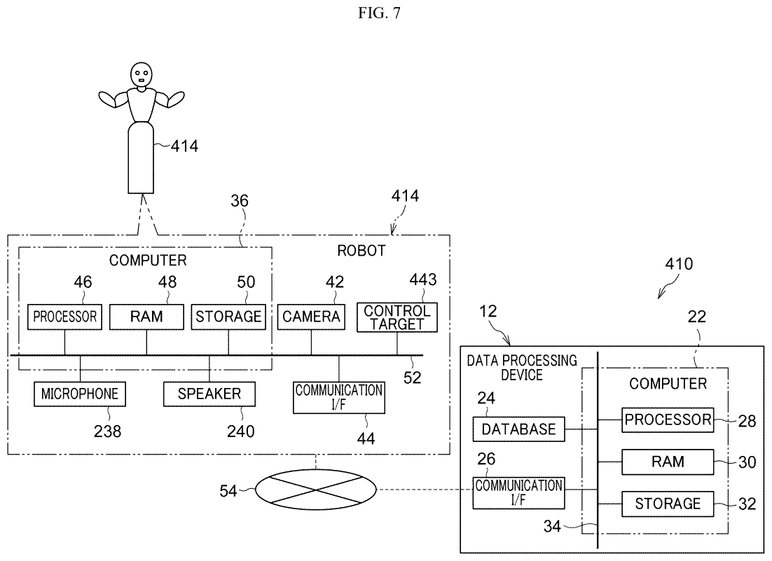

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

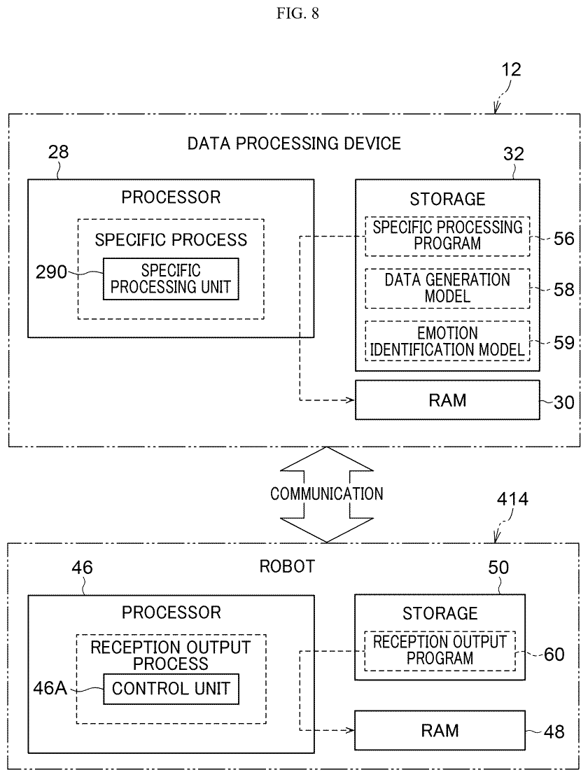

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

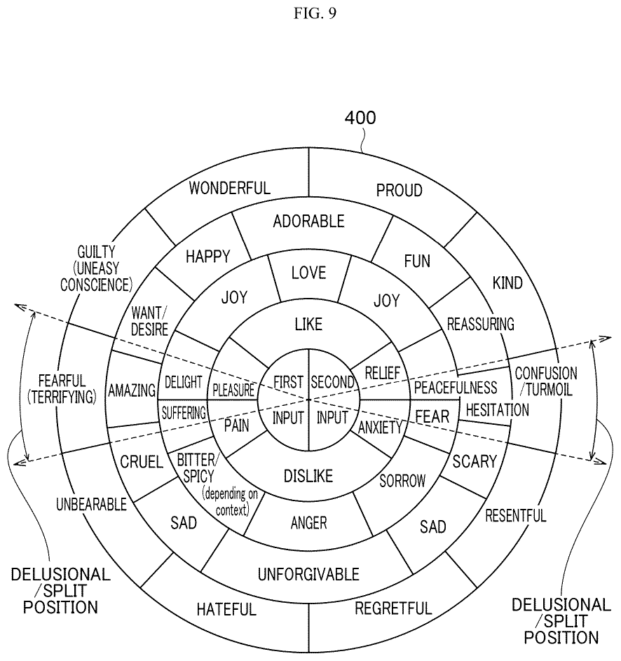

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

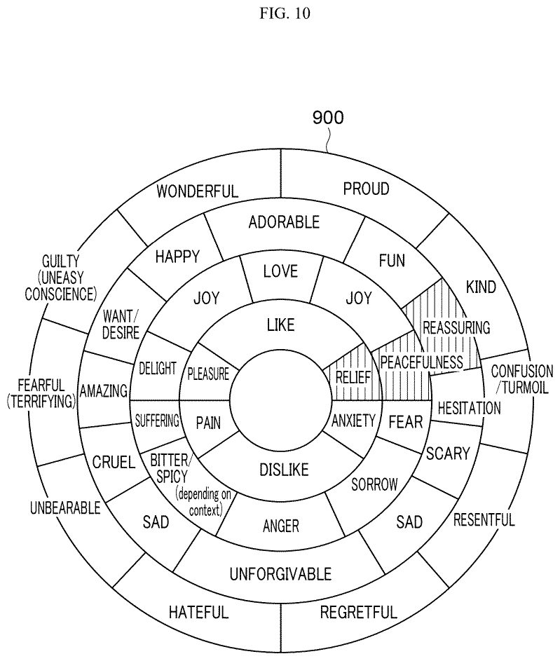

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire and analyze identification information that is assigned on a global scale by obtaining the identification information from information sources on an information network, collect user information including communication information, device information, and location information from a user device, normalize the user information, and store the normalized user information as an internal representation in a storage device,
generate a prompt sentence that instructs a generative information processing model to perform analysis based on the user information, receive an analysis result from the generative information processing model, and determine a usage policy for the user information and the identification information based on the analysis result,
combine at least a part of the user information into a fixed-format character string according to the usage policy and apply a cryptographic transformation function to the character string to generate unique identification information that does not require network address translation,
store, in an information storage device, an association among the generated unique identification information, the user information, and the identification information, and assign and deliver the unique identification information to the user device, and classify and transmit the user information and related information to an appropriate processing function or organizational unit based on the analysis result and the unique identification information.

### Supplementary 2

The system according to supplementary 1,
wherein the processor is configured to
acquire acoustic information of a user, recognize an emotional state of the user by using signal processing technology, and reflect the recognized emotional state in generation of the prompt sentence for the generative information processing model and in generation conditions of the unique identification information.

### Supplementary 3

The system according to supplementary 1,
wherein the processor is configured to
adjust a communication control value to optimize a communication environment based on the recognized emotional state and the unique identification information, and set a communication path or a communication resource between the system and the user device.

### Application Example 1

### Supplementary 1

A system comprising a processor,
wherein the processor is configured to
acquire and analyze information related to globally assigned identification information from a plurality of information storage units over an information communication network, generate and analyze instruction information that is created based on attribute information received from a user and that instructs a generative information processing apparatus to perform analysis,
classify information into a plurality of information processing functions or business functions based on an analysis result provided by the generative information processing apparatus, acquire device configuration information and location information transmitted from a terminal device of the user,
combine the acquired device configuration information and the location information in a predetermined order and format to generate a reference character string, generate unique identification information from the reference character string by using a cryptographic hash operation function,
determine a communication control policy including at least one of permission and rejection of connection in a communication network based on the unique identification information, and
generate and transmit response information for controlling communication from the terminal device in accordance with the communication control policy.

### Supplementary 2

The system according to supplementary 1,
wherein the processor is configured to
acquire voice information of the user, estimate an emotional state by using signal processing technology, and change at least one of content of the instruction information for the generative information processing apparatus and the communication control policy in accordance with the estimated emotional state.

### Supplementary 3

The system according to supplementary 1,
wherein the processor is configured to
convert the unique identification information into a communication path identifier, allocate network resources by using the communication path identifier, and adjust communication environment parameters defining communication quality based on at least one of the location information and the device configuration information of the user.

### Example 2

### Supplementary 1

A system comprising a processor,
wherein the processor is configured to
acquire and analyze information from information sources on an information network, the information including communication information, apparatus information, and location information, in order to identify identification information assigned globally,
receive user information including apparatus identification information and location information from a terminal, and integrate the user information with the information acquired from the information sources to generate a normalized data sequence representing environmental information related to an event,
combine network identification information, apparatus identification information, and location coordinate information included in the normalized data sequence in a predetermined order and format, and generate unique identification information that does not require traversal of a relay device by calculating a fixed-length hash value using a cryptographic hash function,
store in a storage device a correspondence between the unique identification information and the normalized data sequence, reuse the same unique identification information for an identical normalized data sequence, and ensure uniqueness for different normalized data sequences by performing collision detection and re-hashing processing, and
generate and analyze a prompt sentence based on user information or the normalized data sequence, instruct that the prompt sentence be output as an input to a generative AI model, and sort the unique identification information and related information to predetermined business functions or processing functions based on an analysis result from the generative AI model.

### Supplementary 2

The system according to supplementary 1,
wherein the processor is configured to
acquire acoustic information of a user, recognize an emotional state by using signal processing technology, and add the emotional state to the normalized data sequence or the prompt sentence so as to reflect the emotional state in generation of the unique identification information or in analysis by the generative AI model.

### Supplementary 3

The system according to supplementary 1,
wherein the processor is configured to
set communication parameters for optimizing communication conditions based on the recognized emotional state and network information included in the normalized data sequence, and generate the unique identification information by including a setting result of the communication parameters in the normalized data sequence and inputting the normalized data sequence to the cryptographic hash function.

### Application Example 2

### Supplementary 1

A system comprising a processor,
wherein the processor is configured to
acquire and analyze information from information storage resources on an information network in order to identify globally assigned identification information,
receive device information including device identification information and location information from an information terminal, and apply a cryptographic transformation process to input information including the device information, time information, and usage context information to generate unique identification information that does not require cross-network communication or address translation,
acquire user audio information, convert the user audio information into character information by audio signal processing and language analysis processing, and determine a user emotional state by emotion recognition processing,
generate emotion-linked identification information by encoding emotion-dependent priority information into the unique identification information or a communication path identifier on the basis of the device information and the emotional state, and record an association between the emotion-linked identification information and communication quality control information,
generate a prompt sentence that instructs a generative artificial intelligence model to execute analysis processing, request estimation of optimization policies from the generative artificial intelligence model using historical information including the emotion-linked identification information, the communication quality control information, and past communication performance information, and update correspondence rules among emotions, identification information, and communication quality control on the basis of a response from the generative artificial intelligence model,
receive inquiry information or request information from a user, and generate and analyze a prompt sentence that instructs the generative artificial intelligence model to execute analysis processing on the basis of the inquiry information or the request information and the correspondence rules, and
classify the inquiry information or the request information into a service function or a processing department on the basis of an analysis result and the correspondence rules, and control a communication environment by setting or updating communication control conditions of a network control apparatus.

### Supplementary 2

The system according to supplementary 1,
wherein the processor is configured to
aggregate the emotional state, the device information, and information relating to a generation history of the identification information, periodically generate a prompt sentence to be input to the generative artificial intelligence model by using statistical information based on the history, and dynamically change a threshold of the emotion recognition processing and input items of the cryptographic transformation process on the basis of recommendation content output from the generative artificial intelligence model.

### Supplementary 3

The system according to supplementary 1,
wherein the processor is configured to
register the emotion-linked identification information and the communication quality control information in a network management apparatus, and, when the emotional state is determined to include a state of tension, impatience, or fatigue, set bandwidth allocation information, delay control information, and priority information to a high priority for a communication path associated with the emotion-linked identification information, thereby preferentially processing communication requests relating to an electronic payment process, a public wireless access process, or a mobile-body information provision process.

What is claimed is:

1. A system comprising:
circuitry configured to:
obtain, via a communication interface coupled to a packet-switched network, identification information assigned on a global scale by querying information sources on an information network, and analyze the obtained identification information;
collect user information including communication information, device information, and location information from a user device via the communication interface, normalize the user information into a fixed internal representation, and store the normalized user information in a storage device;
generate, based on the normalized user information, a prompt sentence that instructs a generative neural network model to perform analysis, transmit the prompt sentence and context data to the generative neural network model, receive an analysis result, and determine a usage policy for the user information and the identification information from the analysis result;
combine at least a portion of the normalized user information into a fixed-format character string in accordance with the usage policy, apply a cryptographic transformation function to the character string to generate unique identification information that does not require network address translation, and store in the storage device an association among the generated unique identification information, the normalized user information, and the acquired identification information;
assign and deliver the unique identification information to the user device via the communication interface; and
acquire acoustic information from the user device, recognize an emotional state of a user by applying signal processing to the acoustic information, and adjust at least one communication control parameter to optimize a communication path or communication resource between the circuitry and the user device based on the recognized emotional state and the unique identification information.

2. The system according to claim 1, wherein the circuitry is configured to normalize the user information by converting communication information, device information, and location information into a canonical format and storing the normalized fields in a fixed-schema record in the storage device.

3. The system according to claim 2, wherein the circuitry is configured to generate the prompt sentence by extracting at least a subset of the normalized user information fields, encoding the fields as structured context in the prompt sentence, and including an instruction to the generative neural network model to perform policy analysis for the usage policy determination.

4. The system according to claim 3, wherein the circuitry is configured to determine the usage policy by parsing the analysis result received from the generative neural network model, extracting a policy classification and associated parameters, and selecting, based on the policy classification, a combination algorithm and a set of fields for the fixed-format character string.

5. The system according to claim 4, wherein the circuitry is configured to apply the cryptographic transformation function by selecting a hash function or a keyed transformation parameterized by the usage policy, computing the unique identification information from the fixed-format character string, and verifying uniqueness of the generated unique identification information by querying the storage device.

6. The system according to claim 1, wherein the circuitry is configured to recognize the emotional state by applying acoustic feature extraction to the acoustic information to obtain tone, volume, speech rate, and speech pattern features, inputting the extracted features to a trained emotion classification model, and computing an emotional state label and an intensity value.

7. The system according to claim 6, wherein the circuitry is configured to reflect the recognized emotional state in generation of the prompt sentence by appending emotion state information as context in the prompt sentence, directing the generative neural network model to adjust analysis outputs in accordance with the emotional state.

8. The system according to claim 6, wherein the circuitry is configured to adjust the communication control parameter by selecting a communication resource allocation strategy from a set of predefined strategies indexed by emotional state label, applying the selected strategy to modify at least one of bandwidth allocation, packet scheduling priority, or latency target for the communication path associated with the unique identification information.

9. The system according to claim 1, wherein the circuitry is configured to classify the analysis result from the generative neural network model into a service category or a department category, and route a communication session of the user device to a service endpoint associated with the classified service category based on the unique identification information.

10. The system according to claim 9, wherein the circuitry is configured to select the service endpoint by querying the storage device for endpoint records associated with the service category and the unique identification information, applying availability and load-balancing criteria to rank candidate endpoints, and establishing a communication path to the highest-ranked available endpoint.

11. The system according to claim 9, wherein the circuitry is configured to store, in the storage device, a mapping between the unique identification information and the assigned service endpoint as routing history, and use the routing history in subsequent routing decisions for the same user device.

12. The system according to claim 1, wherein the circuitry is configured to retrieve, from the storage device, association records linking the unique identification information to previously collected user information for the same user device, and incorporate the retrieved association records as additional context in the prompt sentence to improve analysis accuracy of the generative neural network model.

13. The system according to claim 12, wherein the circuitry is configured to detect a change in the normalized user information relative to previously stored user information for the same unique identification information, update the association record in the storage device, and regenerate the prompt sentence with updated context data.

14. The system according to claim 1, wherein the circuitry is configured to receive, from external information sources on the information network, updated identification information records, compare the updated records against identification information stored in the storage device, and update stored association records to maintain consistency between globally-assigned identification information and generated unique identification information.

15. The system according to claim 1, wherein the circuitry is configured to monitor a communication quality metric for the communication path associated with the unique identification information, and when the communication quality metric falls below a threshold, invoke the generative neural network model with the communication quality metric and current emotional state information as context to generate a revised communication control parameter set.

16. The system according to claim 15, wherein the circuitry is configured to apply the revised communication control parameter set by adjusting packet-level scheduling parameters, connection establishment parameters, or resource reservation parameters for the communication path of the user device, and record the adjustment in the storage device as a performance optimization event.

17. The system according to claim 1, wherein the circuitry is configured to apply multilingual processing to text information derived from the acoustic information by performing language detection and applying machine translation to convert the text information to a canonical language for prompt generation, and to convert outputs of the generative neural network model back to a language associated with the user device.

18. A system comprising:
circuitry configured to:
obtain, via a communication interface coupled to a packet-switched network, globally-assigned identification information from information sources on an information network, and collect user information including communication information, device information, and location information from a user device;
normalize the user information into a fixed internal representation and store the normalized user information in a storage device;
generate a prompt sentence based on the normalized user information, transmit the prompt sentence and context data to a generative neural network model, receive an analysis result, and determine a usage policy from the analysis result;
combine a portion of the normalized user information into a fixed-format character string in accordance with the usage policy, apply a cryptographic transformation function to generate unique identification information not requiring network address translation, and store an association among the unique identification information, the normalized user information, and the obtained identification information in the storage device;
acquire acoustic information from the user device, apply signal processing to recognize an emotional state of a user, and adjust at least one communication control parameter for a communication path of the user device based on the recognized emotional state and the unique identification information; and
classify the analysis result into a service category, route a communication session of the user device to a service endpoint associated with the service category, and transmit the unique identification information to the user device via the communication interface.

19. The system according to claim 18, wherein the circuitry is configured to reflect the recognized emotional state in the prompt sentence as context information, and to adjust communication resource allocation for the communication path based on an emotional state label and intensity value extracted from the signal processing.

20. A method comprising:
obtaining, via a communication interface coupled to a packet-switched network, identification information assigned on a global scale by querying information sources on an information network, and analyzing the obtained identification information;
collecting user information including communication information, device information, and location information from a user device via the communication interface, normalizing the user information into a fixed internal representation, and storing the normalized user information in a storage device;
generating, based on the normalized user information, a prompt sentence that instructs a generative neural network model to perform analysis, transmitting the prompt sentence and context data to the generative neural network model, receiving an analysis result, and determining a usage policy from the analysis result;
combining at least a portion of the normalized user information into a fixed-format character string in accordance with the usage policy, applying a cryptographic transformation function to generate unique identification information that does not require network address translation, and storing in the storage device an association among the generated unique identification information, the normalized user information, and the acquired identification information;
assigning and delivering the unique identification information to the user device via the communication interface; and
acquiring acoustic information from the user device, recognizing an emotional state of a user by applying signal processing to the acoustic information, and adjusting at least one communication control parameter to optimize a communication path or communication resource based on the recognized emotional state and the unique identification information.
